(19) United States
(12) Patent Application Publication
(10) Pub. No.: US 2013/0064131 A1
(43) Pub. Date: Mar. 14, 2013

(54) APPARATUS AND METHOD FOR TRANSMITTING POWER INFORMATION IN MULTIPLE COMPONENT CARRIER SYSTEM

(71) Applicants: Ki Bum Kwon, Seoul (KR); Jae Hyun Ahn, Seoul (KR); Myung Cheul Jung, Seoul (KR); Eun Kyoung Ko, Seoul (KR)

(72) Inventors: Ki Bum Kwon, Seoul (KR); Jae Hyun Ahn, Seoul (KR); Myung Cheul Jung, Seoul (KR); Eun Kyoung Ko, Seoul (KR)

(73) Assignee: PANTECH CO., LTD., Seoul (KR)

(21) Appl. No.: 13/699,241

(22) PCT Filed: Jun. 16, 2011
(86) PCT No.: PCT/KR11/04435

§ 371 Date: Nov. 20, 2012

(30) Foreign Application Priority Data
Jun. 17, 2010 (KR) 10-2010-0057387
Jun. 24, 2010 (KR) 10-2010-0060123

(51) Int. Cl. H04W 24/10

(52) U.S. Cl. 370/252

(57) ABSTRACT

An apparatus and a method for transmitting power information by a mobile station in a multiple component carrier system includes: obtaining power headroom that is a difference between maximum transmit power of a mobile station for each component carrier and power estimated for actual uplink transmission; configuring an identification field that identifies a component carrier that the power headroom is for; configuring power headroom fields that indicates a level of power headroom; and generating a medium access control protocol data unit (MAC PDU) including the identification field and the power headroom field and transmitting the generated MAC PDU to a base station.

### CROSS-REFERENCE TO RELATED APPLICATIONS

This application is the National Stage Entry of International Application No. PCT/KR2011/004435, filed on Jun. 16, 2011, and claims priority from and the benefit of Korean Patent Application Nos. 10-2010-0057387, filed on Jun. 17, 2010, and 10-2010-0060123, filed on Jun. 24, 2010, all of which are incorporated herein by reference for all purposes as if fully set forth herein.

### BACKGROUND

1. Field

The present invention relates to radio communication, and more particularly, to an apparatus and a method for transmitting power information in a multiple component

2. Discussion of the Background

A radio communication system generally uses a single bandwidth for transmitting data. For example, a second generation radio communication system uses a bandwidth of 200 KHz to 1.25 MHz and a third generation radio communication system uses a bandwidth of 5 MHz to 10 MHz. In order to support increasing transmit capacity, the recent 3GPP LTE has continuously expanded its own bandwidth to 20 MHz or more. In order to increase the transmit capacity, it is essential to increase the bandwidth. However, even when a required level of service is low, supporting a large bandwidth may cause large power consumption.

Therefore, a multiple component carrier system that can define a plurality of carriers having a single bandwidth and a central frequency and transmit and/or receive data in a broadband through the plurality of carriers has been emerged. The multiple component carrier system simultaneously supports a narrowband and a broadband by using at least one carrier. For example, when the single carrier corresponds to a bandwidth of 5 MHz, the multiple component carrier system supports a bandwidth of maximum 20 MHz by using four carriers.

One of the methods for allowing a base station to effectively support resources of a mobile station uses power information regarding the mobile station. A power control technology may be used to minimize interference components so as to effectively distribute resources and reduce battery consumption of the mobile station, in radio communication.

### SUMMARY

The present invention provides a method and an apparatus for transmitting power information, for example, a power headroom report by a mobile station in a multiple component carrier system.

The present invention also provides a method and an apparatus for configuring MAC PDU so as to transmit power information in a multiple component carrier system. For example, the present invention provides a method and an apparatus for reporting power headroom, subtracting a sum of transmit power used in each component carrier from maximum transmit power in a multiple component carrier system.

The present invention also provides a method and an apparatus for transmitting information indicating whether or not to transmit power information in a multiple component carrier system. For example, the present invention provides a method and an apparatus for configuring MAC PDU reporting power headroom, subtracting a sum of transmit power used in each component carrier from maximum transmit power in a multiple component carrier system.

The present invention also provides a method for selectively reporting only power headroom for some of all the configured CCs. In particular, the present invention provides a method and an apparatus for dividing all the configured CCs into several groups and selectively performing a power headroom report that have been divided with only the CCs belonging to a specific group.

The present invention also provides an apparatus and a method for selecting component carriers that are an object of a power headroom report in a multiple component carrier system.

The present invention also provides an apparatus and a method for indicating a group for a power headroom report in a multiple component carrier system.

In an aspect, there is provided a method for transmitting power information of a mobile station, including: determining whether any one of a case in which path loss variations is higher than a specific threshold and a prohibit power headroom report timer expires, a case in which a periodic power headroom report timer expires, and a case in which the power headroom is report is configured or re-configured by an upper layer is occurred in a case in which a mobile station has uplink resources for new transmit; and triggering the power headroom report when any one of the cases is occurred, wherein the power headroom is a difference value between maximum transmit power configured in the mobile station for each component carrier and transmit power estimated for actual uplink transmission, and the power headroom report includes a power headroom identification field that identifies a component carrier that the reported power headroom is for and power headroom fields that indicate a level of the reported power headroom, and the power headroom report is transmitted to a base station through a medium access control protocol data unit (MAC PDU).

The MAC PDU may include an MAC subheader, an MAC control element, and an MAC service data unit (SDU), wherein the MAC subheader may include the power headroom identification field and the MAC control element or the MAC SDU may include the power headroom fields.

The MAC control element may include a mode field that identifies whether the MAC PDU includes the power headroom fields for all the component carriers configured in the mobile station or includes the power headroom fields for some component carriers and the MAC PDU may include a plurality of power headroom identification fields and a plurality of power headroom fields.

The transmit power estimated for the actual uplink transmission may be transmit power of a physical uplink shared channel (PUSCH) or a sum of the transmit power of the PUSCH and transmit power of a physical uplink control channel (PUCCH).

The transmit power estimated for the actual uplink transmission may be a sum of the transmit power of the PUSCH and the transmit power of the physical uplink control channel (PUCCH).

The method for transmitting power information may further include: prior to transmitting the MAC PDU to the base station, requesting uplink scheduling for transmitting the MAC PDU to the base station; and receiving the uplink scheduling information from the base station. In this case, the MAC PDU may be transmitted using uplink resources according to the uplink scheduling information.

The method for transmitting power information may further selecting at least one component carrier, which is a target of the power headroom report, among the plurality of component carriers configured in the mobile station based on a metric using path loss gains of each component carrier as a parameter, wherein the path loss gain is a relative value determined by a difference between theoretical reference signal power of the component carrier and reference signal power actually received by the mobile station.

The metric may perform calculation that compares an amount of the path loss gain with a threshold. In this case, the threshold may be an average of the path loss gain for the plurality of component carriers and the path loss gain for at least one selected component carrier may be equal to or higher than the threshold.

The metric may perform calculation that compares an amount of correlation with the threshold. In this case, the correlation may be obtained based on a difference between the path loss gain and a maximum path loss gain and the maximum path loss gain may be a maximum value among the path loss gains for each of the plurality of component carriers. The correlation may be a reciprocal number of the difference between the path loss gain and the maximum path loss gain. In this case, the threshold may be an average of the correlation for the rest carriers other than the component carriers having the maximum path loss gain among the is plurality of component carriers.

In another aspect, there is provided a method for reporting power headroom in a radio communication system supporting a plurality of component carriers, including: mapping power headroom values subtracting a sum of transmit power used in each component carrier from maximum transmit power of a mobile station to indexes divided by 6 bits configured in consideration of relative parameters of each component carrier; configuring a medium control access (MAC) protocol data unit (PDU) including a header that includes a logical channel ID (LCID) indicating a power headroom report, information that indicates component carriers in which the power headroom report is triggered among the plurality of component carriers, and indexes to which the power headroom values of the triggered component carriers for which the power headroom report triggered are mapped; and transmitting the configured MAC PDU through an uplink.

The information that indicates component carriers in which the power headroom report is triggered among the plurality of component carriers and the indexes to which the power headroom values of the triggered component carriers for which the power headroom report triggered are mapped may be included in a medium control access (MAC) control element of the MAC PDU.

In another aspect, there is provided a method for reporting power headroom in a radio communication system supporting a plurality of component carriers, including: mapping power headroom values subtracting a sum of transmit power used in each component carrier from maximum transmit power of a mobile station to indexes divided by 6 bits configured in consideration of relative parameters of each component carrier; configuring a medium control access (MAC) protocol data unit (PDU) including a header that includes a logical channel ID (LCID) configured corresponding to component carriers in which a power headroom report is triggered among the plurality of component carriers and indexes to which the power headroom values of the triggered component carriers are mapped; and transmitting the configured MAC PDU through an uplink.

In another aspect, there is provided a method for reporting power headroom of a mobile station, including: measuring path loss gains for each of the plurality of component carriers configured in a mobile station; grouping the plurality of component carriers into a plurality of groups by comparing the path loss gains with predetermined conditions; selecting at least one group of the plurality of divided groups; configuring power headroom fields (PH field) that indicate the power headroom values for each of all the component carriers belonging to at least one selected group; and transmitting the MAC PDU including the configured power headroom fields to a base station.

The at least one selected group may be configured of the component carriers indicated by an indicator in a bitmap type received from a base station among the plurality of component carriers.

The at least one selected group may be selected by the mobile station by comparing values for the path loss gains with a predetermined threshold, in the plurality of component carriers.

As set forth above, the exemplary embodiment of the present invention can transmit the information regarding power available by the mobile station for each component carrier by the new MAC PDU format and use the existing resources allocated as the control information as they are to reduce the overhead according to the transmission of the power information. In two MAC PDU structures according to the exemplary embodiment of the present invention, the number of bits of the LCID field of the MAC subheader and the power headroom field of the MAC control element can be remarkably reduced.

In other words, the exemplary embodiment of the present invention can use the reserved fields for the component carriers in which the transmission of the power headroom according to the exemplary embodiment of the present invention is triggered, without increasing the existing LCID field. Therefore, the exemplary embodiment of the present invention can effectively use the defined resources while promoting the accuracy of the transmission of the power headroom of each component carrier.

Further, the exemplary embodiment of the present invention can allow the base station to promote the efficiency of the downlink scheduling and the link adaptation by putting the priority on the transmission of the power headroom of the control information.

The exemplary embodiment of the present invention can reduce the overhead due to the power headroom report while minimizing the transmit power by more effectively allocating the resources to the mobile station using at least two CCs from the base station. In addition, the exemplary embodiment of the present invention can promote the scheduling efficiency of the base station by transmitting and receiving the information regarding the transmit power for CC required for the base station by the mobile station. Therefore, it is possible to efficiently allocate the resources to the mobile station.

### BRIEF DESCRIPTION OF THE DRAWINGS

FIG. 1 is a diagram showing a radio communication system.

FIG. 2 is an explanation diagram for explaining intra-band contiguous carrier aggregation.

FIG. 3 is an explanation diagram for explaining intra-band non-contiguous carrier aggregation.

FIG. 4 is an explanation diagram for explaining inter-band contiguous carrier aggregation.

FIG. 5 is a diagram showing an example of protocol architecture for supporting multiple carriers.

FIG. 6 is a diagram showing an example of a frame structure for a multiple carrier operation.

FIG. 7 is a diagram showing a linkage between downlink component carriers and uplink component carriers in a multiple carrier system.

FIG. 8 is a diagram showing an example of a graph showing power headroom on a time-frequency axis.

FIG. 9 is a diagram showing another example of a graph showing power headroom to which an exemplary embodiment of the present invention is applied on a time-frequency axis.

FIG. 10 is a diagram showing a structure of MAC PDU according to an exemplary embodiment of the present invention.

FIG. 11 is a block diagram showing a structure of an MAC subheader and a power headroom MAC control element according to an exemplary embodiment of the present invention.

FIGS. 12A and 12B are block diagrams showing a structure of an MAC subheader and a power headroom MAC control element according to another exemplary embodiment of the present invention.

FIG. 13 is a diagram showing a structure of an MAC control element according to another exemplary embodiment of the present invention.

FIG. 14 is a block diagram showing a structure of an MAC subheader and an MAC SDU according to an exemplary embodiment of the present invention.

FIG. 15 is a block diagram showing a structure of an MAC subheader and an MAC SDU according to another exemplary embodiment of the present invention.

FIG. 16 is a flow chart for explaining a method for transmitting MAC PDU by a mobile station in a multiple component carrier system according to the exemplary embodiment of the present invention.

FIG. 17 is a block diagram showing an apparatus for transmitting MAC PDU in the multiple component carrier system according to the exemplary embodiment of the present invention.

FIG. 18 is a flow chart for explaining a method for reporting power headroom by a mobile station in the multiple component carrier system according to the exemplary embodiment of the present invention.

FIG. 19 is an explanation diagram for explaining a grouping method according to the exemplary embodiment of the present invention.

FIG. 20 is a flow chart for explaining the grouping method of FIG. 19.

FIG. 21 is an explanation diagram for explaining a grouping method according to another exemplary embodiment of the present invention.

FIG. 22 is a flow chart for explaining the grouping method of FIG. 21.

FIG. 23 is a flow chart for explaining the method for reporting power headroom by a mobile station in the multiple component carrier system according to the exemplary is embodiment of the present invention.

FIG. 24 is a flow chart for explaining a method for reporting power headroom by a mobile station in a multiple component carrier system according to another exemplary embodiment of the present invention.

FIG. 25 is a flow chart for explaining the method for reporting power headroom by a mobile station in the multiple component carrier system according to the another exemplary embodiment of the present invention.

FIG. 26 is a flow chart showing the method for reporting power headroom by a mobile station in the multiple component carrier system according to another exemplary embodiment of the present invention.

FIG. 27 is a block diagram showing an apparatus for reporting power headroom in the multiple component carrier system according to another exemplary embodiment of the present invention.

### DETAILED DESCRIPTION OF THE ILLUSTRATED EMBODIMENTS

Hereinafter, exemplary embodiments will be described in detail with reference to the accompanying drawings. In the specification, in adding reference numerals to components throughout the drawings, it is to be noted that like reference numerals designate like components to even though components are shown in different drawings. In describing the exemplary embodiments of the present invention, detailed descriptions of well-known functions or constructions are omitted so as not to obscure the description of the present invention with unnecessary detail.

Further, the present specification describes a radio communication network as an object. An operation performed in the radio communication network may control a network in a system (for example, a base station) supervising corresponding radio communication networks and may be performed during a process of transmitting data or performed in mobile stations coupled with the corresponding radio networks.

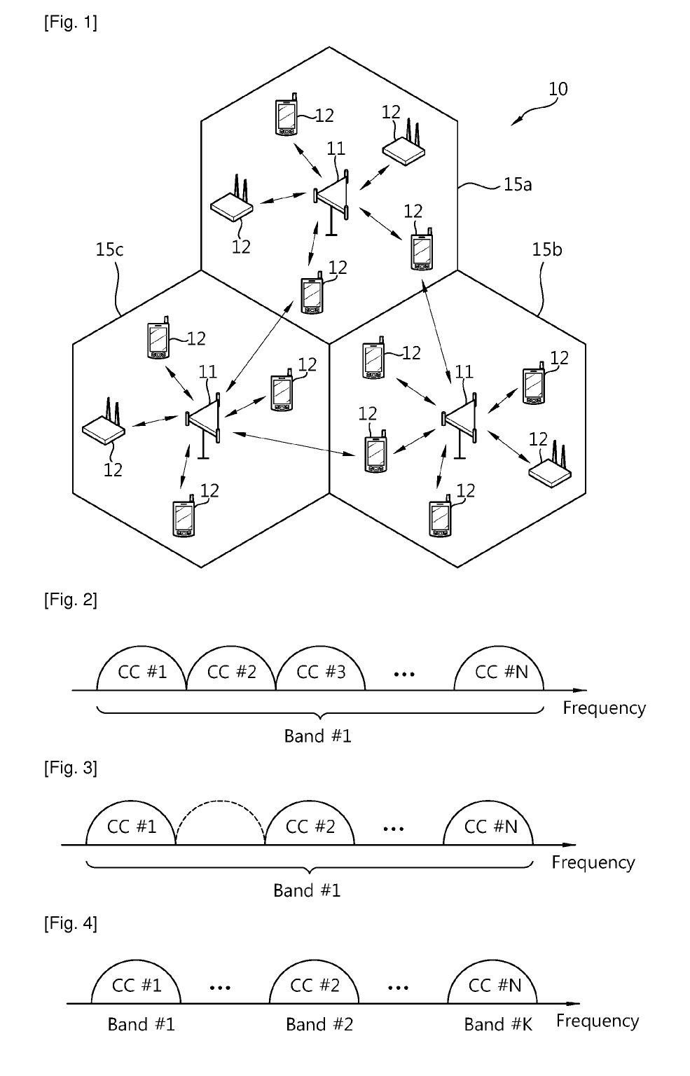

FIG. 1 is a diagram showing a radio communication system.

Referring to FIG. 1, a radio communication system 10 includes at least one base station (BS) 11. Each base station 11 provides communication services to specific geographical areas (generally referred to as cells) 15a, 15b, and 15c. A cell may again be divided into a plurality of areas (referred to as a sector).

A mobile station (MS) 12 may be fixed or moved and may be referred to as other terms, such as user equipment (UE), a mobile terminal (MT), a user terminal (UT), a subscriber station (SS), a wireless device, personal digital assistant (PDA), a wireless modem, a handheld device, or the like.

The base station 11 is generally referred to as a fixed station communicating with the mobile station 12 and may be referred to as other terms, such as evolved-node B (Enb), a base transcriber system (BTS), an access point, or the like. The cell is to be comprehensively interpreted as some areas are covered by the base station 11 and can include all of the various coverage areas such as a mega cell, a macro cell, a micro cell, a pico cell, a femto cell, or the like.

Hereinafter, a downlink means communication from the base station 11 to the mobile station 12 and an uplink (UL) means communication from the mobile station 12 to the base station 11. At the downlink, a transmitter may be a portion of the base station 11 and a receiver may be a portion of the mobile station 12.

At the uplink, the transmitter may be a portion of the mobile station 12 and the receiver may be a portion of the base station 11.

In the radio communication system, various multiple access methods such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, OFDM-CDMA, or the like, may be used. The uplink transmission and the downlink transmission may use a time division duplex (TDD) method that performs transmit at different time or may use a frequency division duplex (FDD) method that performs transmit at different frequencies.

Carrier aggregation (CA) supporting a plurality of carriers is referred to as spectrum aggregation or bandwidth aggregation. An individual unit carrier tied by the carrier aggregation is referred to as component carrier (hereinafter, referred to as CC). Each CC is defined as a bandwidth and a central frequency. The carrier aggregation increases throughput and secure compatibility with the existing systems.

For example, a bandwidth with a maximum of 20 MHz may be supported when five CCs are allocated as granularity in a carrier unit having, for example, a bandwidth of 5 MHz.

The carrier aggregation may be divided into intra-band contiguous carrier aggregation as shown in FIG. 2, intra-band non-contiguous carrier aggregation as shown in FIG. 3, and inter-band carrier aggregation as shown in FIG. 4.

Referring first to FIG. 2, the intra-band contiguous carrier aggregation is performed between the continuous CCs within the same band. For example, all of CC#1, CC#2, CC#3, . . . , CC#N that are the aggregated CCs are contiguous to each other.

Referring to FIG. 3, the intra-band non-contiguous carrier aggregation is performed between the discontinuous CCs. For example, CC#1 and CC#2 that are the aggregated CCs are spaced apart from each other by a specific frequency.

Referring to FIG. 4, the inter-band carrier aggregation is in a form in which when the plurality of CCs are present, at least one among them is aggregated on different frequency bands. For example, CC#1 among the aggregated CCs is present in band#1 and CC#2 is present in band#2.

The number of carriers aggregated between the downlink and the uplink may be set to be different from each other. A case in which the number of downlink CCs is equal to the number of uplink CCs may be referred to as symmetric aggregation and a case in which the number of downlink CCs is different from the number of uplink CC is referred to asymmetric aggregation.

In addition, a size (that is, a bandwidth) of CCs may be different from each other. For example, when five CCs are used to configure of a 70 MHz band, they may be configured, like 5 MHz CC(carrier #0)+20 MHz CC(carrier#1)+20 MHz CC(carrier#2)+20 MHz CC(carrier#3)+5 MHz CC(carrier#4).

Hereinafter, the multiple carrier system is referred to as a system that supports the carrier aggregation. In the multiple carrier system, the contiguous carrier aggregation and/or the non-contiguous carrier aggregation may be used and either of the symmetric aggregation or the non-symmetric aggregation may be used.

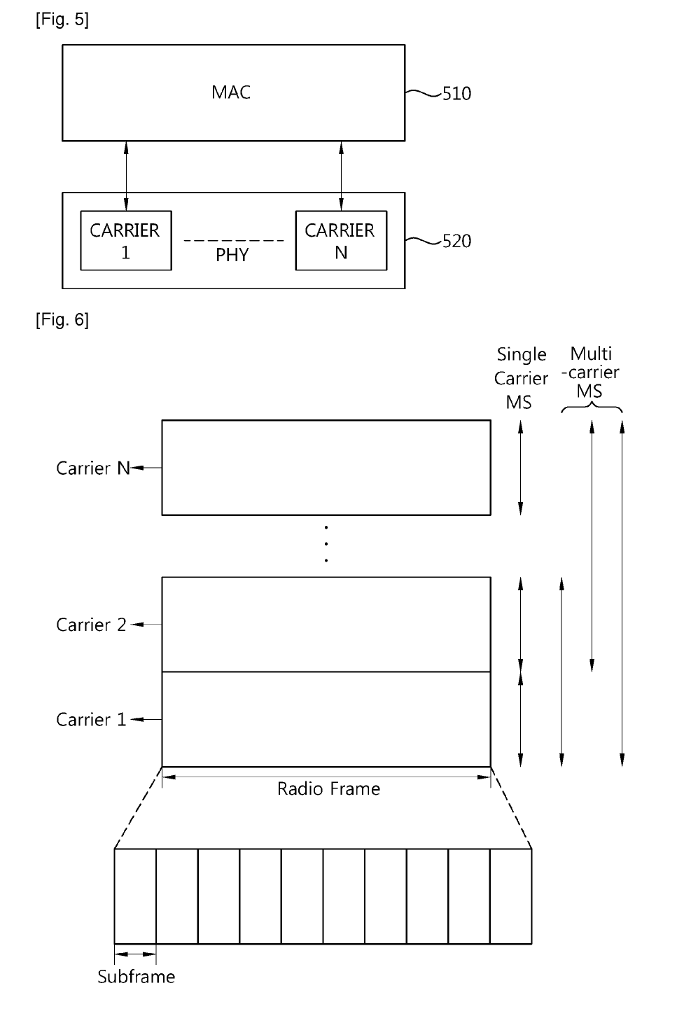

FIG. 5 shows an example of protocol architecture for supporting the multiple carriers.

Referring to FIG. 5, a common medium access control (MAC) individual 510 is manages a physical layer 520 that uses a plurality of carriers. An MAC management message that is transmitted by a specific carrier may be applied to different carriers. That is, the MAC management message is a message that may control different carriers, including the specific carrier. The physical layer 520 may be operated by time division duplex (TDD) and/or frequency division duplex (FDD).

There are some physical control channels used in the physical layer 520. A physical downlink control channel (PDCCH) that transmits physical control information informs the mobile station of information regarding resource allocation of a paging channel (PCH) and a downlink shared channel (DL-SCH) and hybrid automatic repeat request (HARQ) associated with the DL-SCH. The PDCCH may carry an uplink grant that informs the mobile station of the resource allocation of the uplink transmission.

A physical control format indicator channel (PCFICH) informs the mobile station of the number of OFDM symbols used for the PDCCHs and transmits the number of OFDM symbols for each subframe. A physical hybrid ARQ indicator channel (PHICH) carries HARQ ACK/NAK signals as the response of the uplink transmission. A physical uplink control channel (PUCCH) carries the uplink control information such as HARQ ACK/NAK for downlink transmission, scheduling request, CQI, or the like. A physical uplink shared channel (PUSCH) carries an UpLink shared channel (UL-SCH).

FIG. 6 shows an example of a frame structure for a multiple carrier operation.

Referring to FIG. 6, a radio frame is configured to include 10 subframes. The subframe includes a plurality of OFDM symbols. Each CC may have their own control channels (for example, PDCCH). The CCs may be contiguous to each other or may not be contiguous to each other. The mobile station may support at least one CC according to its own capability.

CC may be divided into a primary component carrier (PCC) and a secondary component carrier (SCC) according to whether CC is activated. The PCC is a carrier that is activated at all times and the SCC is a carrier that is activated/non-activated according to specific conditions.

The activation means a state in which the transmission or reception of traffic data is performed or is ready. The non-activation means a state in which the transmission or reception of traffic data cannot be performed but the measurement or the transmit/receive of minimum information can be performed.

The mobile station may use only one PCC or at least one SCC together with the PCC. The mobile station may be allocated with the PCC and/or the SCC from the base station. The PCC is a carrier that exchanges main control information between the base station and the mobile station. The SCC is a carrier allocated according to a request of the mobile station or an indication of the base station. The PCC may be used to enter the mobile station into the network and/or allocate the SCC. The PCC may not be fixed to the specific carrier and the carrier configured as the SCC may be changed into the PCC.

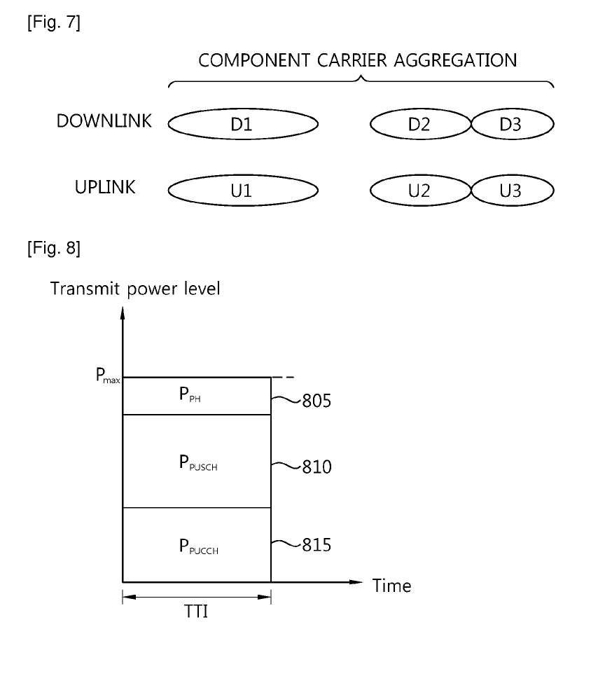

FIG. 7 shows an example of a linkage between downlink component carriers and uplink component carriers in the multiple carrier system.

In the example of FIG. 7, the downlink component carriers (hereinafter, referred to as DL CC) D1, D2, and D3 are aggregated at the downlink and the uplink component carriers (hereinafter, referred to as UL CC) U1, U2, and U3 are aggregated at the uplink. In this case, Di indicates an index of the DL CC and Ui indicates an index of the UL CC (i=1, 2, 3). At least one DL CC is the PCC and the rest are the SCC. Similarly, at least one UL CC is the PCC and the rest are the SCC. For example, in the case of FIG. 7, the D1 and U1 may be the PCC and the D2, U2, D3, and U3 may be the SCC.

In the FDD system, the DL CCs are linked with the UL CCs on a one-to-one basis and the D1 and the U1, the D2 and the U2, and the D3 and the U3, respectively, are linked with each other on a one-to-one basis. The mobile station performs the linkage between the DL CCs and the UL CCs through system information transmitted by a logical channel BCCH and mobile station-only RRC messages transmitted by DCCH. Each linkage may be set to be cell specific and may be set to be UE specific.

An example of the UL CC linked with the DL CC is as follows.

1) The UL CC that allows the mobile station to transmit ACK/NACK information in response to the data transmitted through the DL CC by the base station;

2) The DL CC that allows the base station to transmit ACK/NACK information in response to the data transmitted through the UL CC by the mobile station;

3) The DL CC transmits the response in the case in which the base station receives a random access preamble (RAP) transmitted through the UL CC by the mobile station starting a random access procedure; and

4) The UL CC to which the uplink control information is applied when the base station transmits the uplink control information through the DL CC, or the like.

FIG. 7 shows, by way of example, only the one-to-one linkage between the DL CCs and the UL CCs; however, a 1:n or n:1 linkage may also be established. Further, the index of the component carrier does not necessarily correspond to an order of the component carriers or positions of frequency bands of the corresponding component carriers.

Power headroom (PH) will be described below.

For example, it is assumed that the mobile station has maximum transmittable is power of 10 W. Further, it is assumed that the current mobile terminal uses a frequency band of 10 Mhz and an output of 9 W. In this case, when the frequency band of 20 Mhz is allocated to the mobile station, power of 9 W×2=18 W is needed. However, since the maximum power of the mobile station is 10 W, when 20 Mhz is allocated to the mobile station, the mobile station cannot use all the frequency bands or the base station cannot receive signals from the mobile station due to underpower as they are.

Meanwhile, it is general that data are unexpectedly generated in response to the characteristics and the amount thereof is not constant. Therefore, when the mobile station has data to be transmitted to the base station, the base station may allocate an appropriate amount of radio resources to the mobile station if the base station receives the power headroom report that is received in advance from the mobile station before the generation of data.

Further, since the power headroom is frequently changed, a periodic power headroom report method has been used. According to the periodic power headroom report method, the mobile station triggers the power headroom report when a periodic timer expires and re-drives the periodic timer when the power headroom is reported.

In addition to this, even when path loss (PL) estimates measured by the mobile station are changed above a predetermined reference value, the power headroom report is triggered. The path loss estimates are measured by the mobile station based on reference symbol to received power (RSRP).

The power headroom P_{PH} is defined as a difference between maximum output power Pₘₐₓ configured in the mobile station and power P_{estimated} for the uplink transmission depending on Equation 1 and is represented by dB.

P_{PH}=Pₘₐₓ−P_{estimated}[dBm] [Equation 1]

The power headroom PH may be referred to as power headroom PH, remaining power, or power headroom. That is, at the maximum transmit power of the mobile station configured by the base station, the rest of the values other than the P_{estimated} that is a sum of the transmit power used in each component carrier become the P_{PH} value.

As an example, there may be the case that the P_{estimated} is equal to the power

P_{PUSCH} estimated for the transmission of the physical uplink shared channel (PDSCH). In this case, the P_{PH} may be obtained depending on Equation 2.

P_{PH}=Pₘₐₓ−P_{PUSCH}[dBm] [Equation 2]

As another example, there may be the case in which the P_{estimated} is equal to the sum of the power P_{PUSCH} estimated for the transmission of the PUSCH and the power P_{PUCCH} estimated for the transmission of the PUCCH (physical uplink control channel) In this case, the P_{PH} may be obtained depending on Equation 3.

P_{PH}=Pₘₐₛ−P_{PUCCH}−P_{PUSCH}[dBm] [Equation 3]

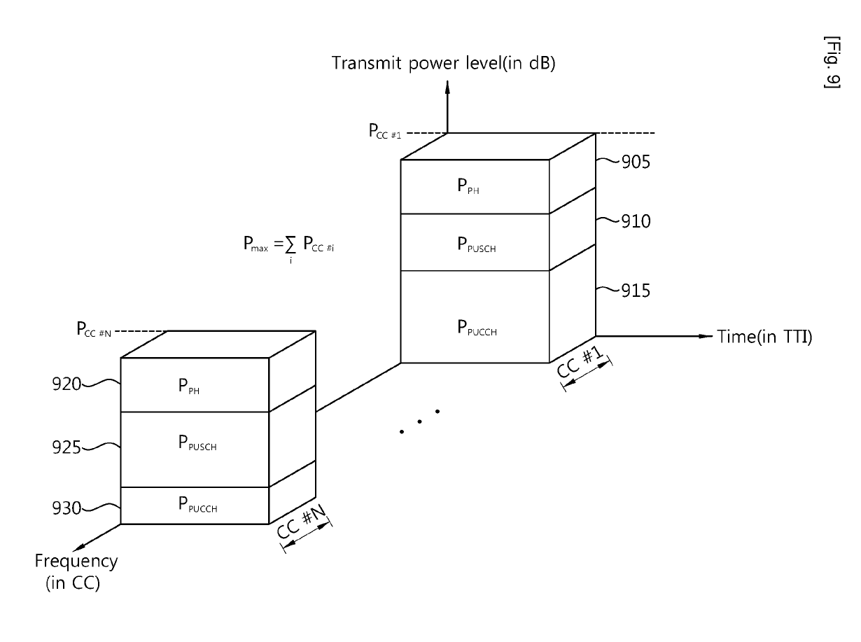

FIG. 8 shows the P_{PH} depending on Equation 3 that is represented by a graph on a to time-frequency axis. This represents the P_{PH} for single CC.

Referring to FIG. 8, maximum output power Pₘₐₓ configured in the mobile station is configured to include P_{PH} 805, P_{PUSCH} 810, and P_{PUCCH} 815. That is, at the Pₘₐₓ, the rest of the power headroom other than the P_{PUSCH} 810 and the P_{PUCCH} 815 is defined as the P_{PH} 805. Each power is calculated in each transmit time interval (TTI) unit.

The power headroom for the plurality of CCs may be individually defined in the multiple component carrier system, which is represented by a graph on the time-frequency axis as shown in FIG. 9.

Referring to FIG. 9, the maximum output power Pₘₐₓ configured in the mobile station is equal to the sum of the maximum output power P_{CC#1}, P_{CC#2}, . . . , P_{CC#N} for each CC#1, CC#2, . . . , CC#N.

When the case depending on Equation 3 under the assumption that P_{CC#1}=P_{CC#2}= . . . =P_{CC#N}=P_{CC} is described by way of example, P_{PH} 905 of CC#1 is equal to PCC−P_{PUSCH} 910−P_{PUCCH} 915 and P_{PH} 920 of CC#N is equal to P_{CC}−P_{PUSCH} 925−P_{PUCCH} 930. The maximum output power level for each CC is constantly defined and the P_{PH}, P_{PUSCH}, and P_{PUCCH} are present at different ratios for each CC. That is, the case in which the power ratio for each CC is allocated differently is general.

The presence of the plurality of CCs means that multiple path loss may be present. Further, the power headroom may be different for each CC due to the multiple path loss

For example, when CC#1, CC#2, and CC#3 are allocated to the mobile station, the power headroom P_{PH1} for CC#1 may be −8 dB, the power headroom P_{PH2} for each CC#2 may be −10 dB, and the power headroom P_{PH3} for CC#3 may be 0 dB. As described above, since the power headroom may be different for each CC, the mobile station may transmit the field (hereinafter, referred to as the power headroom) representing the power headroom values for each CC to the base station.

The power headroom field (PH field), which is an information field representing a is power headroom value, may have a size of 6 bits as an example. The following Table 1 shows an example of a head power field table representing the power headroom field and the power headroom value.

TABLE 1

| PH field | Power Headroom Level | Measured Quantity Value(dB) |
|---|---|---|
| 0 | Power Headroom_0 | −23 ≦ P_{PH} ≦ −22 |
| 1 | Power Headroom_1 | −22 ≦ P_{PH} ≦ −21 |
| 2 | Power Headroom_2 | −21 ≦ P_{PH} ≦ −20 |
| 3 | Power Headroom_3 | −20 ≦ P_{PH} ≦ −19 |
| . . . | . . . | . . . |
| 60 | Power Headroom_60 | −37 ≦ P_{PH} ≦ −38 |
| 61 | Power Headroom_61 | −38 ≦ P_{PH} ≦ −39 |
| 62 | Power Headroom_62 | −39 ≦ P_{PH} ≦ −40 |
| 63 | Power Headroom_63 | P_{PH} ≧ −40 |

Referring to Table 1, the power headroom value is included in the range between −23 dB and +40 dB. When the power headroom field is 6 bits, 2⁶=64 indexes may be represented. The power headroom value may be divided into a total of 64 levels.

As an example, when the power headroom field is 0 (000000 when represented by 6 bits), the power headroom value of CC corresponding to the corresponding power headroom field represents −23≦P_{PH}≦22 dB. The plurality of power headroom fields may be present within the single MAC PDU. The reason is that the plurality of CCs may be present and the power headroom may be differently configured for each CC, in the multiple carrier system.

The power headroom field, which is a message corresponding to the MAC level, is processed by an MAC layer. Therefore, the power headroom field is included in the MAC PDU. In particular, the power headroom field may be included in an MAC control element (CE) and/or an MAC payload.

As an example, all the power headroom fields may be included in the MAC is control element or the MAC payload.

For example, a first power headroom field for CC#1 may be included in a first MAC control element and a second power headroom field for CC#2 may be included in a second MAC control element. Alternatively, the first power headroom field for CC#1 may be included in a first MAC payload and a second power headroom field for CC#2 may be included in a second MAC payload.

As another example, some power headroom fields may be included in the MAC control element and the rest power headroom fields may be included in the MAC payload. For example, the first power headroom field for CC#1 may be included in the first MAC control element and the second power headroom field for CC#2 may be included in the first MAC payload.

In order to describe in more detail the MAC control element and the MAC payload including the power headroom field, the structure of the MAC PDU will be first described.

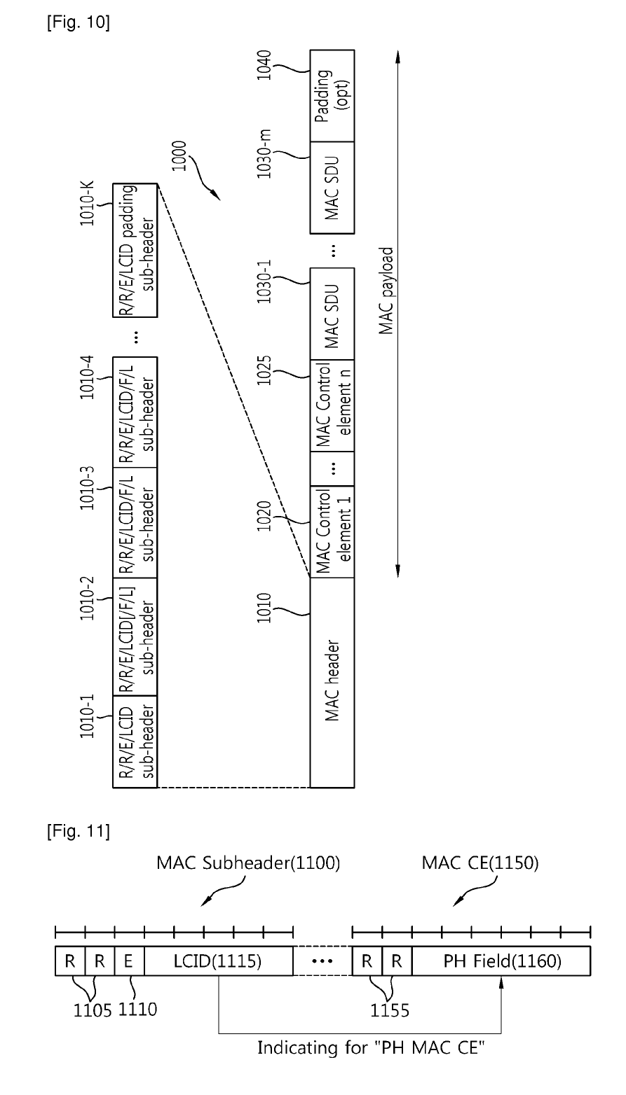

FIG. 10 shows the structure of the MAC PDU according to the exemplary embodiment of the present invention. The MAC PDU is referred to as a transport block (TB).

Referring to FIG. 10, an MAC PDU 1000 includes an MAC header 1010, at least one MAC control element 1020, . . . , 1025, at least one MAC service data unit (SDU) 1030-1, . . . , 1030-m, and padding 1040.

The MAC control elements 1020 and 1025 are control messages generated by the MAC layer. When the MAC control elements 1020, . . . , 1025 include the power headroom field, the MAC control elements 1020, . . . , 1025 are referred to as the power headroom MAC control elements.

The MAC SDUs 1030-1, . . . , 1030-m correspond to RLC PDUs that are transmitted from a radio link control (RLC) layer. The padding 1040 is a predetermined number of bits that is added so as to make the size of the MAC PDU constant. The MAC control elements 1020, . . . , 1025, the MAC SDUs 1030-1, . . . , 1030-m, and the padding 1040 are collectively referred to as the MAC payload.

The MAC header 1010 includes at least one sub-header 1010-1, 1010-2, . . . , 1010-k and each subheader 1010-1, 1010-2, . . . , 1020-k corresponds to a single MAC SDU, a single MAC control element, or the padding. An order of the subheaders 1010-1, 1010-2, . . . , 1010-k are arranged to be identical with an order of the corresponding MAC SDU, MAC control element, or paddings within the MAC PDU 1000.

Each subheader 1010-1, 1010-2, . . . , 1010-k may include four fields such as R, R, E, and LCID or six fields such as R, R, E, LCID, F, and L. The subheader including four fields is a subheader corresponding to the MAC control element or the padding and the subheader to including six fields is a subheader corresponding to the MAC SDU.

The R field is the remaining extra bits. The E field is an extended field that indicates whether additional LCID fields are present in the subheader. The length field (L field) indicates the length of the corresponding MAC SDU or a variable-sized MAC control element as a byte. The F field is a format field that indicates the size of the L field.

The logical channel ID (LCID) field, which is an identification field identifying the logical channel corresponding to the MAC SDU or the type of the MAC control element or the padding may be 5 bits. For example, the LCID field identifies whether the corresponding MAC control element is a power headroom MAC control element for transmitting the power headroom, a feedback request MAC control element requesting feedback information to the mobile station, a discontinuous reception (DRX) instruction MAC control element for discontinuous receiving instructions, a contention resolution identity MAC control element for contention resolution between the mobile stations, or the like.

Further, according to the exemplary embodiment of the present invention, the LCID field may indicate whether the power headroom MAC control element includes the power headroom field for any CC. A single LCID field is present for the MAC SDU, the MAC control element, or the padding, respectively. When the MAC control element or the MAC payload includes the power headroom field, the LCID field may indicate whether the power headroom field corresponds to any CC.

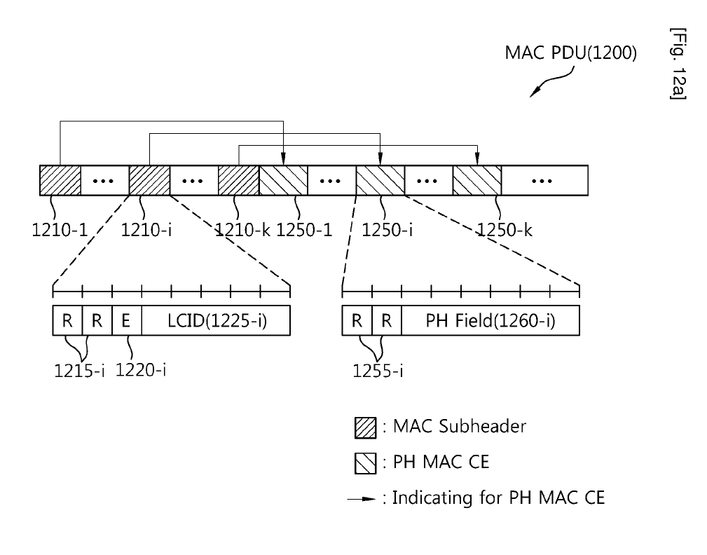

FIG. 11 is a block diagram showing the structure of the MAC subheader and the power headroom MAC control element according to the exemplary embodiment of the present invention. This corresponds to the case in which the power headroom MAC control element includes the power headroom field.

Referring to FIG. 11, a power headroom MAC control element (MAC CE) 1150 includes two R fields 1155 and a power headroom field (PH field) 1160 and the MAC subheader 1100 includes two R fields 1105, an E field 1110, and an LCID field 1115.

As described above, the E field 1110 is an extended field that indicates whether the additional LCID field 1115 is present in the subheader. The fact that the E field 1110 is set to is be 1 means that a set of another LCID field 1115 and E field 1110 is continued immediately after the E field 1110. The fact that the E field 1110 is set to be 0 means that the MAC payload is continued immediately after the E field 1110.

Meanwhile, the fact that the LCID field 1115 indicates that the corresponding MAC control element is the power headroom MAC control elements (PH, MAC, CE) means that the corresponding power headroom MAC control element includes the power headroom field 1160. Further, with the field value the LCID field 1115 may indicate for which CC the power headroom field 1160 is. In this case, the reserved field values among the LCID field values may be used as the field values required to indicate for which CC the power headroom field is for. Table 2 shows an example of the LCID field 1115 according to the exemplary embodiment of the present invention.

TABLE 1

| Index | LCID values |
|---|---|
| 00000 | CCCH |
| 00001-01010 | Identity of the logical channel |
| 01011-10101 | Reserved |
| 10110 | Power Headroom Report for CC#1 |
| 10111 | Power Headroom Report for CC#2 |
| 11000 | Power Headroom Report for CC#3 |
| 11001 | Power Headroom Report for CC#4 |
| 11010 | Power Headroom Report for CC#5 |
| 11011 | C-RNTI |
| 11100 | Truncated BSR |
| 11101 | Short BSR |
| 11110 | Long BSR |
| 11111 | Padding |

Table 2 shows an example of using the values from 01011 to 11010 among the reserved values for indicating for which CC the corresponding power headroom report is if it is assumed that the values from 01011 to 11010 is the reserved field values. Referring to Table 2, the LCID field values from 10110 to 11010 indicate that the power headroom field 1160 of the MAC control element 1150 indicates the power headroom value for any one of CC#1, CC#2, CC#3, CC#4, and CC#5, while indicating that the corresponding MAC control element 1150 is the power headroom MAC control element. That is, according to the exemplary embodiment of the present invention, the LCID field 1115 may indicate for which CC the power headroom field 1160 is.

For example, if the LCID field value is 10110, the LCID field value indicates that the power headroom field 1160 is for CC#1 and if the LCID field value is 11010, the LCID field value indicates that the power headroom field 1160 is for CC#5. By the above-mentioned method, the power headroom fields for the plurality of CCs may be identified for each CC. The mapping between the index and CC indication is only an example and therefore, is not necessarily made as in Table 2.

As described above, if it is assumed that N CCs are configured in the mobile station, it is possible to indicate for which CC the power headroom field is configured by using the N field values (indexes) among the reserved field values (indexes) of the LCID field. Therefore, when transmitting the power headroom fields for N CCs, the N subheaders including is the LCID field of 5 bits is configured.

Meanwhile, the power headroom field of the MAC control element may indicate the power headroom level of 64 levels by allocating 6 bits to each CC, as described above.

The plurality of power headroom field may be transmitted through the single MAC PDU or the plurality of MAC PDUs. As an example, the mobile station may transmit the power headroom fields for all CCs or the power headroom fields for some CCs to the base station by using the single MAC PDU.

For example, the mobile station may transmit both of the first power headroom field for CC#1 and the second power headroom field for CC#2 that are included in the single MAC PDU. If the power headroom field is 6 bits, the number of bits required for the single MAC PDU to transmit two power headroom fields is 2 (the number of CCs)×6 (bits/CC)=12 bits. That is, the number of bits required to transmit the power headroom fields for N CCs is obtained from the following Equation 4.

N_{PHfields}=6N, where N32 the number of CC [Equation 4]

Where N_{PHfields} indicate a total number of bits required to transmit all the power headroom fields and N indicates the number of CCs.

As another example, the power headroom fields for each CC may separately be transmitted through the MAC PDU of the corresponding CC. For example, the first power headroom field for CC#1 may be transmitted through CC#1 while being included in the first MAC PDU, the second power headroom field for CC#2 may be transmitted through CC#2 while being included in the second MAC PDU, and the third power headroom field for CC#3 may be transmitted through CC#3 while being included in the third MAC PDU.

As another example, the power headroom fields for each CC may separately be transmitted through the MAC PDU of any CC. For example, the first power headroom field for CC#1 is transmitted through CC#1 while being included in the first MAC PDU and both of the second power headroom field for CC#2 and the third power headroom field for CC#3 may be transmitted through CC#2 while being included in the second MAC PDU.

FIG. 12A is a block diagram showing the structure of an MAC subheader and a power headroom MAC control element according to another exemplary embodiment of the present invention.

Referring to FIG. 12A, an MAC PDU 1200 includes a plurality of MAC subheaders 1210-1, . . . , 1210-i, . . . , 1210-k and includes a plurality of power headroom MAC control elements (PH, MAC, CE) 1250-1, . . . , 1250-i, and 1250-k (i≦k). The MAC subheader 1210-i includes two R fields 1215-i, an E field 1220-i, and an LCID field 1225-i. Therefore, as described above, the MAC subheader 1210-i is a subheader corresponding to the MAC control element. The power headroom MAC control element 1250-i includes two R fields 1255-i and a power headroom field 1260-i.

FIG. 12A shows that the power headroom MAC control elements 1250-i including the power headroom field 1260-i is present in plural, while FIG. 11 shows that the power headroom MAC control element 1150 including the power headroom field 1160 is present in one. Therefore, FIG. 12A is different from FIG. 11. Table 2 may be an example of the LCID field 1225-i for FIG. 12A.

For example, when k CC, CC#1, . . . , CC #k is configured in the mobile station, the MAC PDU 1200 includes k MAC subheaders 1210-1, . . . , 1210-k and k power headroom MAC is control elements 1250-1, . . . , 1250-k.

In this case, the MAC subheader 1210-i includes the LCID field 1225-i and the LCID field 1225-i indicates for which CC the power headroom field 1260-i is. For example, if the LCID field value is 10110, the LCID field value indicates that the corresponding power headroom field is for CC#1. By the above-mentioned method, if the value of the LCID field 1225-2 is 10111, the value of the LCID field 1225-2 indicates that the power headroom field 1260-2 is for CC#2 and if the value of the LCID field 1225-3 is 11000, the value of the LCID field 1225-3 indicates that the power headroom field 1260-3 is for CC#3.

FIG. 12A describes the case in which the plurality of power headroom fields are transmitted within the single MAC PDU, which is by way of example only. Therefore, as described above, the plurality of power headroom fields may be transmitted by being divided into the plurality of MAC PDUs.

FIG. 12B is a block diagram showing the structure of an MAC subheader and a power headroom MAC control element according to another exemplary embodiment of the present invention.

Referring to FIG. 12B, the MAC PDU 1200 includes the plurality of MAC subheaders 1210-1, . . . , 1210-j, . . . , 1210-m and includes the plurality of power headroom MAC control elements (PH, MAC, CE) 1250-1, . . . , 1250-j, and 1250-m (j≦m).

The MAC subheader 1210-j includes an R1 field and an R2 field 1215-j, an E field 1220-j, and an LCID field 1225-j. Therefore, as described above, the MAC subheader 1210-j is a subheader corresponding to the MAC control element. The power headroom MAC control element 1250-j includes an R′ field and an R2′ field 1255-j and a power headroom field 1260-j.

FIG. 12B shows that the power headroom MAC control elements 1250-j is including the power headroom field 1260-j is present in plural, while FIG. 11 shows that the power headroom MAC control element 1150 including the power headroom field 1160 is present in one. Therefore, FIG. 12B is different from FIG. 11. Table 3 shows an example of the LCID field 1225-j for the case of FIG. 12B.

TABLE 3

| Index | LCID values |
|---|---|
| 00000 | CCCH |
| 00001-01010 | Identity of the logical channel |
| 01011-11001 | Reserved |
| 11010 | Power Headroom Report for CC |
| 11011 | C-RNTI |
| 11100 | Truncated BSR |
| 11101 | Short BSR |
| 11110 | Long BSR |
| 11111 | Padding |

Referring to Table 3, the LCID field 1225-j indicates that the corresponding MAC control element 1250-j is the power headroom MAC control element, but does not indicate for which CC the power headroom field 1260-j is. For example, if the value of the LCID field 1225-j is 11010, the LCID field 1225-j indicates that the corresponding MAC control element 1250-j is the power headroom MAC control element.

Unlike the case of FIG. 12A, the case of FIG. 12B indicates for which CC the power headroom field 1260-j is with the R1 and R2 fields 1215-j of the subheader and/or the R1′ and R2′ fields 1255-j of the power headroom MAC control element, not with the LCID field. In other words, it is possible to indicate for which CC the power headroom field is by using the reserved subheader and/or the R field of the MAC control element.

For example, when three R fields selected from the R1, R2, R1′, and R2′ fields are used, it is possible with 2³=8 CCs maximally to indicate for which CC the corresponding power headroom field is. Alternatively, when two R fields selected from the R1, R2, R1′, and R2′ fields are used, it is possible with 2²=4 CCs at most to indicate for which CC the power headroom field is.

CC configured in the mobile station is 5 in total and three R fields are to be used so as to represent for which CC among the five CCs the power headroom field is. Three R fields may be any of the R1 and R2 fields 1215-j and the R′ and R2′ fields 1255-j. The following Table 4 shows an example in which the specific CC is indicated by three R fields.

TABLE 4

| CC index | Indication bits (3 bits: RLCID R1PH R2PH) |
|---|---|
| CC1 | 000 |
| CC2 | 001 |
| CC3 | 010 |
| CC4 | 011 |
| CC5 | 100 |

In the case of FIG. 12B, even though N CCs are configured in the mobile station, only one index (field value) is used in a field table of the LCID in connection with the power headroom report. In other words, whether the MAC control element is the power headroom MAC control element may be indicated by configuring only one LCID field for each MAC PUD so as to transmit the power headroom field and whether the power headroom field is for any CC may be indicated by using each subheader and/or the reserved field of the power headroom MAC control element. The power headroom field of the MAC control element may have a size of 6 bits for each CC and may indicate the level of the power headroom as 64 levels.

Unlike Table 4, when only one CC is used, there is no need to indicate for which CC the power headroom field is, such that the R field is set to be the reserved field.

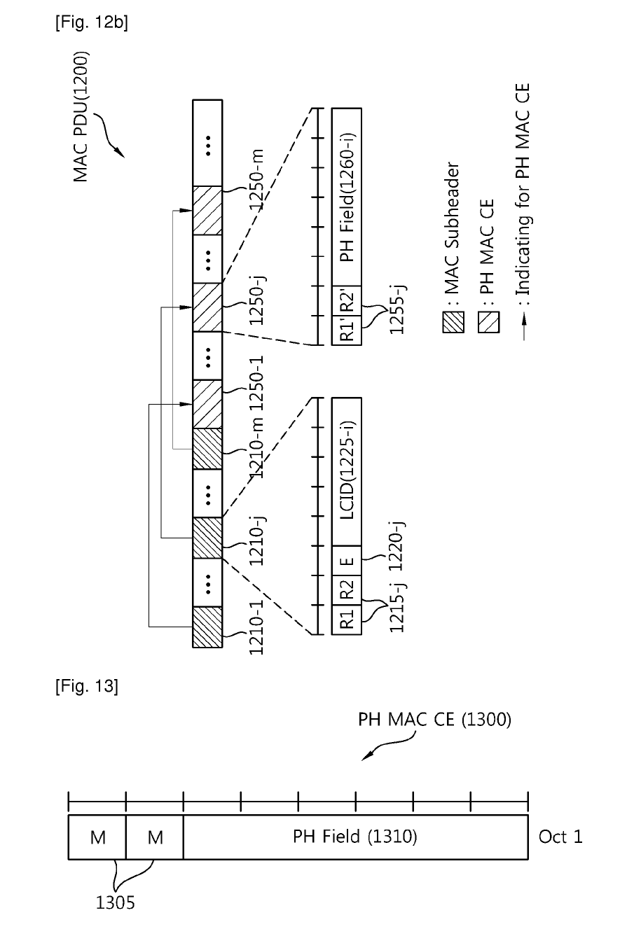

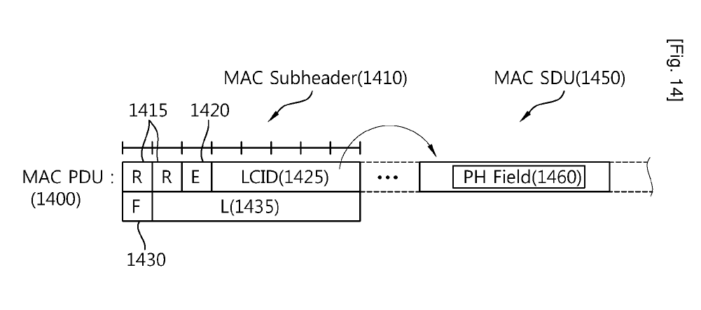

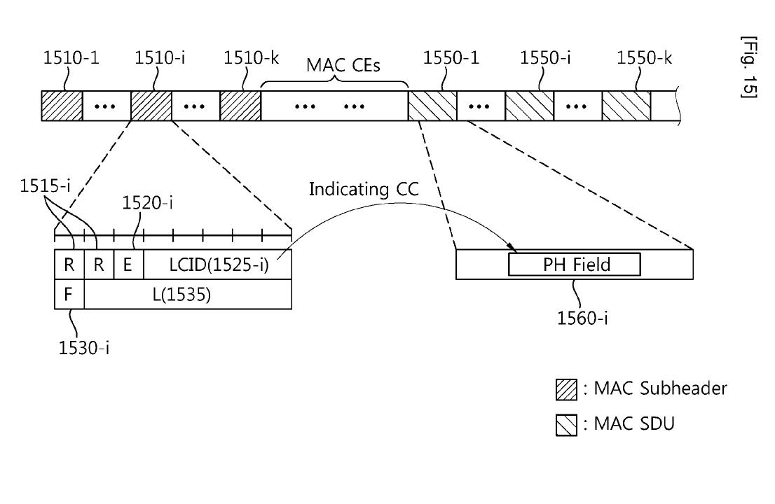

FIG. 13 is a diagram showing a structure of an MAC control element according to another example of the present invention.

Referring to FIG. 13, a power headroom MAC control element 1300 includes two mode fields (M field) 1305 and a power headroom field (PH field) 1310. FIG. 13 is different from FIG. 11 in that the power headroom MAC control element 1300 includes two M fields 1305 instead of two R fields 1155. The M field 1305 indicates whether the corresponding MAC PDU includes the power headroom fields for all CCs or only the power headroom fields for some CCs.

For example, when CC configured in the mobile station is CC#1, CC#2, and CC#3 and the single M field 1305 is 0, it indicates that the corresponding MAC PDU includes all of the power headroom field for CC#1, the power headroom field for CC#2, and the power to headroom field for CC#3.

To the contrary, CC indicates that the corresponding MAC PDU includes only the power headroom fields for some CCs, for example, CC#1 and CC#2 if any one M field 1305 is 1. In addition, ones indicated by the M field 1305 may be changed. In this case, whether the power headroom field 1310 of the power headroom MAC control element is for any CC may be is indicated by the LCID field of the MAC subheader as shown in the Table 2.

Meanwhile, since the base station may implicitly know whether the power headroom fields or some power headroom fields for all of CCs are transmitted according to the presence and absence of the LCID field and the power headroom field 1310 corresponding thereto, the M field 1305 may be omitted.

FIG. 14 is a block diagram showing a structure of the MAC subheader and the MAC SDU according to the exemplary embodiment of the present invention. This corresponds to the case in which the power headroom field is included in the MAC SDU.

Referring to FIG. 14, an MAC PDU 1400 includes an MAC subheader 1410 and an MAC SDU 1450. The MAC SDU 1450 includes a power headroom field (PH field) 1460 and the MAC subheader 1410 includes two R fields 1415, an E field 1420, an LCID field 1425, an F field 1430, and an L field 1435. Therefore, as described above, in the case of FIG. 14, the MAC subheader 1410 including six fields is a subheader corresponding to the MAC SDU 1450. With the field value, the LCID field 1425 indicates for which CC the power headroom field 1460 is. The above Table 2 shows an example of the LCID field 1425.

The E field 1420 is an extended field that indicates whether the additional LCID field 1425 and L field 1435 are present in the subheader. The fact that the E field 1420 is set to be 1 means that a set of another LCID field 1425 and E field 1420 is continued immediately after the E field 1420. The fact that the E field 1420 is set to be 0 means that the MAC payload is continued immediately after the E field 1420. The L field 1435 is a field indicating of the length of the corresponding MAC SDU 1450 and the single L field 1435 for each MAC SDU 1450 included in the MAC PDU 1400 is present. The F field is a format field that indicates the size of the L field.

FIG. 15 is a block diagram showing a structure of an MAC subheader and an MAC SDU according to another exemplary embodiment of the present invention. This corresponds to the case in which the MAC SDU includes the power headroom field.

Referring to FIG. 15, an MAC PDU 1500 includes MAC subheaders 1510-1, . . . , 1501-i, . . . , 1510-k and the MAC SDUs 1550-1, . . . 1550-i, . . . 1550-k. The MAC SDU 1550-i includes a power headroom field (PH field) 1560-i and the MAC subheader 1510-i includes two R fields 1515-i, an E field 1520-i, an LCID field 1525-i, an F field 1530-i, and an L field 1535-i.

With the field value, the LCID field 1525-i indicates for which CC the power headroom field 1560-i is. An example of the LCID field 1525-i may include the above table 2. The above-mentioned method may identify the CC of K CCs that the power headroom field is for.

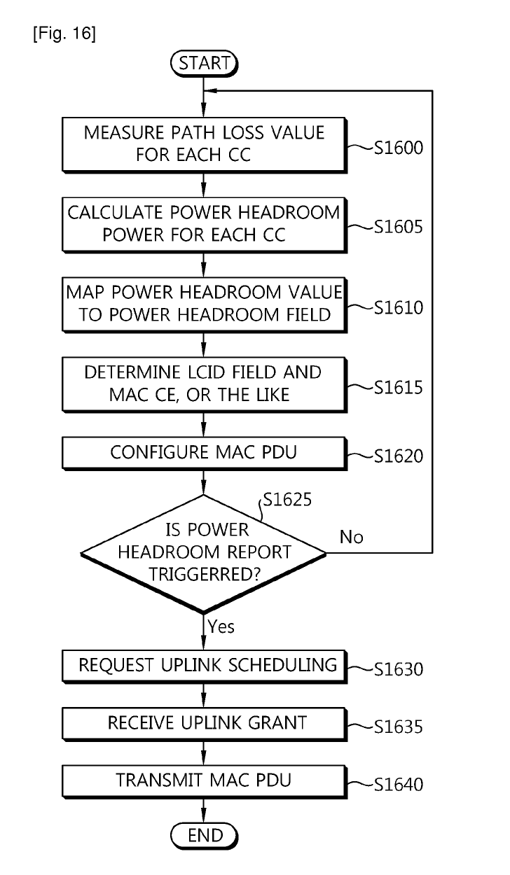

FIG. 16 is a flow chart for explaining a method for transmitting MAC PDU by the mobile station in the multiple component carrier system according to the exemplary embodiment of the present invention.

Referring to FIG. 16, the motion station measures the path loss values for each of the plurality of CCs (S1600).

In the LTE system to which the exemplary embodiment of the present invention is applied, the data transmission of the uplink is performed through an uplink common channel. In this case, one of factors required to allow the mobile station to determine the transmit power of the uplink common channel is path loss estimates. The value is measured by the mobile station based on reference symbol received power (RSRP).

Meanwhile, a closed-loop power control is to allow the mobile station to control the uplink transmit power by transmit power control (TPC) instructions. The TPC instructions is are transmitted to the mobile station by the base station based on a target signal to interference plus noise ratio (Target SINR) and a measured received SINR. The base station request the mobile station so as to increase the transmit power when the targeted SINR is higher than the SINR by the TPC instructions, while the base station requests the mobile station so as to reduce the transmit power when the targeted SINR is lower than the SINR.

The mobile station obtains the power headroom for each CC based on the measured path loss values for each CC (S1605).

For example, when the power headroom is defined according to the above Equation 2, if the maximum transmit power and the PUSCH transmit power for CC#1 each are Pₘₐₓ₁ and P_{PUSCH1}, the maximum transmit power and the PUSCH transmit power for CC#2 each are Pₘₐₓ₂ and P_{PUSCH2}, the power headroom for CC#1 is Pₘₐₓ₁−P_{PUSCH1} and the power headroom for CC#2 is Pₘₐₓ₂−P_{PUSCH2}.

The mobile station maps the obtained power headroom values for each CC to the power headroom fields, respectively, by referring to the power headroom field table (S1610). The above-mentioned Table 1 is an example of the power headroom field table.

When the power headroom field for each CC is determined, the mobile station should inform the base station of which CC the power headroom field is for. To this end, the LCID field may be used and the LCID field and the reserved fields of the MAC subheader and to the power headroom MAC CE may be used.

Therefore, the mobile station determines the LCID field and the MAC CE (S1615). As an example, the LCID field may be determined by referring to the LCID field table of the above Table 2.

If the power headroom fields for CC#1 and CC#3 are generated as an example, is the field values of the LCID field may each be 10110 and 11000.

As another example, the LCID field may be determined by referring to the LCID field table of the above Table 3.

In the case of the LCID field table of the above Table 3, the LCID field serves to indicate that the power headroom field is transmitted through only the corresponding MAC PDU, not separately indicating for which CC the power headroom field is for. Therefore, in the case of reporting the power headroom, the LCID field becomes 11010.

Meanwhile, when the LCID field is determined by referring to the LCID field table such as the above Table 3, it is possible to indicate for which CC the power headroom field is by the R field of the R field of the MAC subheader and/or the R field of the MAC control element. This is described in detail with reference to FIG. 12B. That is, when the LCID field is 10110 as the case of reporting the power headroom, the LCID field may indicate for which CC the power headroom field mapped as shown in Table 4 is by using the R field. The mobile station configures the determined LCID field and the MAC PDU including the mapped power headroom field (S1620).

The LCID field is included in the MAC subheader of the MAC PDU. In addition, the power headroom field is included in the power headroom MAC control element of the MAC PDU and/or the MAC payload.

As an example of the case in which the power headroom field is included in the MAC control element (CE), when the mobile station performs the power headroom report for CC#1 and CC#4, the MAC PDU may be configured as shown in the following Table 5. The MAC PDU configured by the LCID field table of the above Table 2 is referred to as Type 1 and the MAC PDU configured by the LCID field table of the above Table 3 is referred to as Type 2.

TABLE 5

| | MAC PDU | | | | | | | | | | | | | |
|---|---|---|---|---|---|---|---|---|---|---|---|---|---|---|
| | MAC Subheader1 | | | | MAC Subheader2 | | | | MAC CE1 | | | MAC CE2 | | |
| Type | R | R | E | LCID | R | R | E | LCID | R | R | PH Field | R | R | PH FIELD |
| 1 | — | — | — | 10110 | — | — | — | 11001 | — | — | 00011 | — | — | 11101 |
| 2 | 0 | 0 | — | 11010 | 0 | 1 | — | 11010 | 0 | 1 | 00111 | 1 | — | 01001 |

For convenience of explanation, the above Table 5 indicates the case of the MAC PDU configured as two MAC subheaders and two MAC control elements as an example. Referring to the above Table 5, the MAC PDU is sorted into Type 1 and Type 2. Type 1 has the MAC PDU structure according to FIG. 12A and Type 2 has the MAC PDU structure according to FIG. 12B.

First, the MAC PDU of Type 1 is configured to include MAC subheader 1, MAC subheader 2, MAC control element 1 (MAC CE1), and MAC control element 2 (MAC CE2).

As described above, Type 1 determines the LCID field value by using the LCID field table of the above Table 2. The LCID field value of MAC subheader 1 is 10110 and thus, indicates that the MAC control element 1 corresponding to the MAC subheader 1 includes the power headroom field for CC#1 when referring to the above Table 2. In addition, the power headroom field value of the MAC control element 1 corresponding to the MAC subheader 1 is 00011 and thus, indicates that the power headroom value for CC#1 is −20≦P_{PH}≦−19, when referring the above Table 1.

In addition, the LCID field value of MAC subheader 2 is 11001 and thus, is indicates that the MAC control element 2 corresponding to the MAC subheader 2 includes the power headroom field for CC#4 when referring to the above Table 2. In addition, the power headroom field value of the MAC control element 2 corresponding to the MAC subheader 2 is 11101 and thus, indicates that the power headroom value for CC#4 is 38≦P_{PH}≦39 when referring to FIG. 1. In the case of Type 1, the R field included in the MAC subheader and the MAC control element does not include separate information.

Next, the MAC PDU of Type 2 is configured to include the MAC subheader 1, the MAC subheader 2, the MAC control element 1, and the MAC control element 2, similar to Type 1. As described above, Type 2 determines the LCID field value by using the LCID field table of the above Table 3. Unlike Type 1, the LCID field of all of the MAC subheaders are 11010 and thus, indicates that the MAC control element is the power headroom MAC control element when referring to the above Table 3.

In the case of Type 2, it is possible to indicate for which CC the power headroom fields of each MAC control element are by the R field (the R field of the subheader and/or the MAC control element). Referring to the above Table 5, in the case of Type 2, the values of two R fields of the MAC subheader 1 are 00 and the value of the first R field value of the MAC control element 1 is 0. According to the above Table 4, since 000 indicates CC#1, it can be appreciated that the power headroom field of the MAC subheader 1 is for CC#1.

Similarly, the values of two R fields of the MAC subheader 2 is 01 and the value of the first R field of the MAC control element 2 is 1. According to the above Table 4, since 011 indicates CC#4, it can be appreciated that the power headroom field of the MAC subheader 2 is for CC#4.

In addition, as another example, in the case of Type 2, CC indicating the is transmission of the power headroom field may be indicated by using the values of the two R fields of the MAC subheader 1 and the first R field of the MAC control element 1 or the values of the two R fields of the MAC subheader 1 and the first R field of the MAC control element 2. In this case, the presence and absence of the MAC control element 2 may be indicated by using the L field indicating the length of the MAC subheader. In addition, in the case of Type 2, the LCID field of the MAC subheader 2 may be configured to be identical with the LCID field of the MAC subheader 1. Alternatively, actual values may not be allocated.

Meanwhile, as described above, the MAC control element may further include the M field indicating whether the power headroom fields for all CCs configured in the mobile station are transmitted (first mode) or only the power headroom fields for some CCs are transmitted (second mode).

As described above, when the MAC PDU includes the LCID fields and the power headroom fields for the plurality of CCs, the base station may obtain the power headroom information for each CC therefrom. For example, in an example of Type 1 of Table 9, the base station may obtain the first power headroom field for CC#1 by the first LCID field and may know the power headroom for CC#1 therefrom. In addition, the base station may obtain a fourth power headroom field for CC#4 by the second LCID field and may know the power headroom for CC#4 therefrom.

The mobile station determines whether the power headroom report is triggered (S1625).

When the power headroom transmit is triggered, the mobile station requests uplink scheduling to the base station (S1630) and receives uplink grant (S1635). In this case, the mobile station requests the uplink scheduling to all CCs. Thereafter, the mobile station receives is the uplink grants for each CC among all the CCs or the uplink grants for the selected CCs.

Alternatively, the mobile station request the uplink scheduling to all the CCs so as to report the power headroom or request the uplink scheduling to the selected CCs so as to report the power headroom. Thereafter, the mobile station receives the uplink grants for each CC among all the CCs so as to report the power headroom or the uplink grants for the selected CCs so as to report the power headroom.

Further, the mobile station transmits the configured MAC PDU(s) to the base station by using the uplink resources according to the received uplink grant (S1640).

In this case, the MAC PDU(s) may be transmitted through the P_{CC} and may separately be transmitted to each CC. At step 1640, the MAC PDU configured in connection with the power headroom report for all CCs is transmitted through the single CC or may be transmitted through the plurality of CCs. In this case, the single CC may be the P_{CC} and the plurality of CCs may include the P_{CC}, including the SCCs.

As an example, when the power headroom report is performed on all CC1 to CC5, the transmission of the MAC PDU configured for CC1 to CC5 is performed through CC2 if the P_{CC} is CC2. Alternatively, the transmission of the MAC PDU configured for CC1 to CC5 is performed through CC2 that is the P_{CC} and CC3 that has the good channel state, that is, the large power headroom value. Alternatively, the transmission of the MAC PDU configured for CC1 to CC5 is performed through CC1 and CC3 to CC5, including CC2 that is the P_{CC}.

Meanwhile, at step 1640, the MAC PDU configured in connection with the power headroom report for the selected CCs may be transmitted through one of the selected CCs or through the plurality of selected CCs.

As an example, when the power headroom report is performed on all of CC1 to CC3 and CC5, the transmission of the MAC PDU configured for CC1 to CC3 and CC5 is performed through CC2 if the P_{CC} is CC2. Alternatively, the transmission of the MAC PDU configured for CC1 to CC3 and CC5 may be performed through CC2 that is the P_{CC}, any CC4 that has the good channel state, and CC5. Alternatively, the transmission of the MAC PDU configured for CC1 to CC3 and CC5 is performed through CC1 to CC3 and CC5, including CC2 that is the P_{CC}.

If the transmission of the power headroom is not triggered, the mobile station measures the next path loss value (s1600) and repeats the following steps.

The condition in which the transmission of the power headroom is triggered may be any one of the following conditions.

In the case in which the mobile station has the uplink resources for new transmit, when a prohibit power headroom report timer expires as the case in which the path loss variations are higher than the specific threshold.

When the periodic power headroom report timer expires.

When the power headroom report is configured or re-configured by the upper layer.

The power headroom is measured at a period for each one subframe. In addition, the power headroom report is measured only in the subframe in the case in which the PUSCH is transmitted. In addition, a delay of the power headroom report is defined by an interval between a start timing of a power headroom reference period and timing when the mobile station starts to transmit the power headroom field to the radio interface.

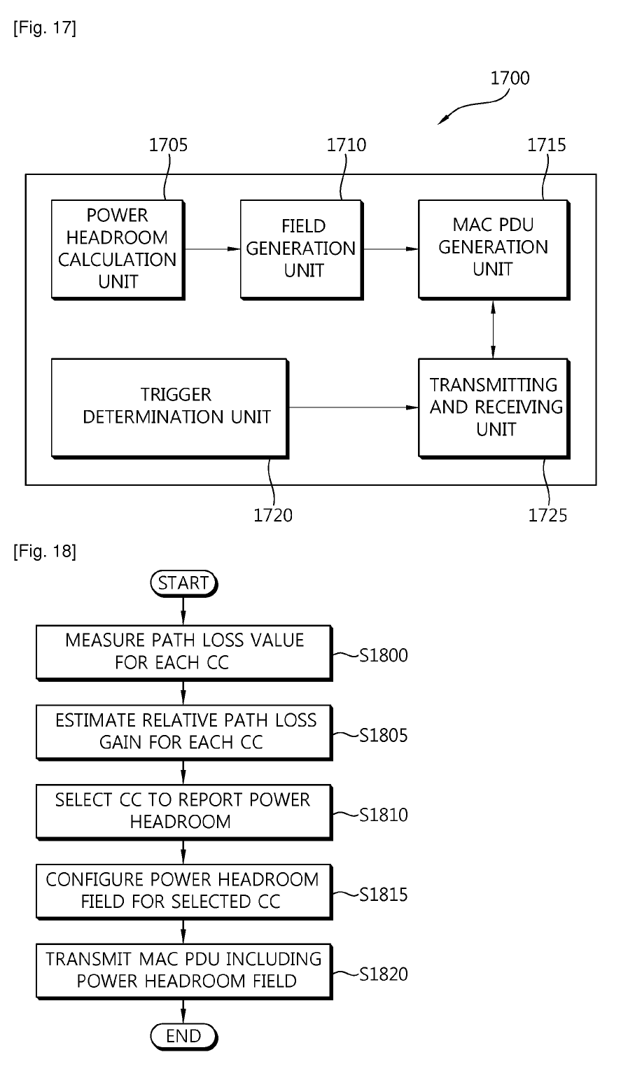

FIG. 17 is a block diagram showing an apparatus for transmitting MAC PDU in the multiple component carrier system according to the exemplary embodiment of the present invention. The apparatus for transmitting MAC PDU may be a portion of the mobile station.

Referring to FIG. 17, an apparatus for transmitting MAC PDU 1700 includes a power headroom calculation unit 1705, a field generation unit 1710, an MAC PDU configuration unit 1715, a trigger determination unit 1720, and a transmitting and receiving unit 1725.

The power headroom calculation unit 1705 calculates the power headroom for each CC based on the maximum transmit power of the mobile station and the power estimated for the uplink transmission. The method for calculating power headroom depends on the Equations 1 to 3.

The field generation unit 1710 generates various fields required to transmit the power headroom for the plurality of CCs, that is, at least one LCID field, at least one power headroom field, and at least one M field. The LCID field is generated by referring to the LCID field table of the above Table 2 and table 3 and may indicate for which CC the corresponding power headroom field is. Each power headroom field indicates the level of the power headroom values of the mobile station for each CC as shown in the above Table 1 and the M field indicates the transmit mode of the power headroom field, that is, whether the power headroom fields for all the CCs configured in the mobile station are transmitted or only the power headroom fields for some CCs are transmitted.

The MAC PDU configuration unit 1715 generates the MAC subheader based on the LCID field and generates the power headroom MAC control element and/or the MAC SDU based on the power headroom field and the MA field. The MAC PDU configuration unit 1715 configures the MAC PDU based on the MAC subheader and the MAC control element and/or the MAC SDU. The MAC PDU configuration unit 1715 may include the power headroom field for all CCs in the single MAC PDU and may be dispersedly included in the plurality of MAC PDUs.

The trigger determination unit 1720 determines whether the power headroom report is triggered. The power headroom report means that the MAC PDU is transmitted. The conditions of triggering the power headroom report may include i) in the case in which the mobile station has the uplink resources for new transmit, when a prohibit power headroom report timer expires as the case in which the path loss variations are higher than the specific threshold, ii) when the periodic power headroom report timer expires, and iii) when the power headroom report is configured or re-configured by the upper layer, or the like.

When the power headroom report is triggered by the trigger determination unit 1720, the trigger determination unit indicates the transmission of the MAC PDU to the transmitting and receiving unit 1725 and the transmitting and receiving unit 1725 transmits the MAC PDU.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

Meanwhile, the number of bits required to transmit the power headroom field for all CCs configured in the mobile station is proportional to the number of CCs. For example, when the power headroom field is 6 bits and the configured CCs are five in total, 5 CCs×6 bits/CC=30 bits are required. When the power headroom field is included in the MAC PDU, the MAC subheader including the R field, the E field, the LCID field, or the like and the R field on is the MAC payload, or the like, are additionally required so as to transmit the power headroom field.

Therefore, the number of bits actually required to report the power headroom report is two times or more the number of bits of the power headroom field, which may be served as the overhead. Since the carrier aggregation is a technology introduced to transmit high-capacity data transmit at high speed, a need exists for a method of reducing the amount of resources consumed so as to report the power headroom.

For example, the amount of resources used to report the power headroom may be reduced by selectively reporting only the power headroom for some of all the configured CCs.

In the specification, CCs selected as the target of the power headroom report are referred to as PHR enable CCs and a set of PHR enable CCs is referred to as a PHR enable group. Further, CCs that are not selected as the target of the power headroom report is referred to as PHR disable CCs and a set of the PHR disable CCs is referred to as a PHR disable group. The PHR enable CCs and the PHR disable CCs are not fixed but may be continuously changed. The reason is that path loss gains of each CC may be frequently changed.

For example, at the first subframe, the PHR enable group is {CC#1, CC#2, CC#3} and the PHR disable group is {CC#4, CC#5}. However, at the second subframe, the PHR enable group may be changed to {CC#2, CC#4} and the PHR disable group may be changed to {CC#1, CC#3, CC#5}. Hereinafter, CC grouping means a process of dividing all the configured CCs into several groups based on the specific reference.

FIG. 18 is a flow chart for explaining a method for reporting power headroom by the mobile station in the multiple component carrier system according to the exemplary embodiment of the present invention.

Referring to FIG. 18, the mobile station measures the path loss values for each CC (S1800). In the multiple component carrier system to which the exemplary embodiment of the present invention is applied, the data transmission of the uplink is performed through the uplink common channel. In this case, one of factors required to allow the mobile station to determine the transmit power of the uplink common channel is the path loss estimate. The estimates are measured by the mobile station depending on Equation 5 based on the reference symbol received power (RSRP).

PL_{UE}_{_{—}}_{estimated}=P_{BS}_{_{—}}_{TX}−RSRP_{avg}[dB] [Equation 5]

P_{LUE}_{_{—}}ₑₛₜᵢₘₐₜₑ is the path loss value estimated by the mobile station, P_{BS}_{_{—}}_{TX} is a power value of a reference signal to be theoretically received, RSRP_{avg} is a power value of the reference signal actually received by the mobile station.

The mobile station measures relative path loss gains for each CC (S1005). An example of the method for measuring path loss gains depends on the following Equation 6.

PL_{Gain}=Kd^{-α} [Equation 6]

Where PL_{Gain} indicates the path loss gain, K indicates a path loss constant, d indicates a transmit distance between the base station and the mobile station, and q indicates a path loss index.

The channel gain reflects the path loss gain and thus, shows the channel conditions. That is, when the channel gain is represented by a sum of a large-scale fading gain and a small-scale fading gain, the path loss gain corresponds an element of the large-scale fading gain. Meanwhile, the relative path loss gain indicates a normalized path loss gain.

The mobile station selects the PHR enable CCs by comparing the relative path loss gains for each CC with the predetermined conditions (S1010). The PHR enable CCs configures a group of CCs satisfying the predetermined conditions, that is, the PHR enable group.

As an example, the mobile station may select CCs having the relative path loss gains equal to or higher than the threshold as the PHR enable CCs or may select CCs having the relative path loss gains lower than the threshold as the PHR enable CCs.

As another example, the mobile station may select as the PHR enable CCs CCs in which the correlation with CC having the maximum relative path loss gain is equal to or higher than the threshold or may select as the PHR enable CCs CCs in which the correlation with CC having the maximum relative path loss gain is lower than the threshold. That is, the mobile station may select CCs having the relative path loss gains of the same or similar patterns as the PHR enable CCs.

The mobile station configures the power headroom fields for the selected PHR enable CCs (S1015). The power headroom fields are configured for each of the selected PHR enable CCs and may be calculated by any one of the above Equations 1 to 3. Further, the range of the values of the power headroom fields may be determined by the power headroom field table as shown in the above Table 1.

The mobile station transmits the MAC PDU including the power headroom field to the base station (S1020). The structure of the MAC PDU including the power headroom field is as described with reference to FIG. 10.

All the power headroom fields for each CC belonging to the PHR enable group may be included in the single MAC control element 1 1020 and each of the power headroom is fields for each CC belonging to the PHR enable group may be included in each MAC control element 1020, . . . , 1025. Alternatively, all the power headroom fields for each CC belonging to the PHR enable group may be included in the single MAC SDU 1030-1 and each of the power headroom fields for each CC belonging to the PHR enable group may be included in each MAC SDU 1030-1, . . . , 1030-m.

As described above, the mobile station may report only the power headroom for CC belonging to the PHR enable group to the base station and may not report the power headroom for CC belonging to the PHR disable group to the base station. The power headroom for CC of the PHR disable group is not reported such that the scheduling of the base station may be unstable. As a result, CC is to be selected so as to minimize the influence of the scheduling.

Hereinafter, the method for selecting the PHR enable CCs according to the exemplary embodiment of the present invention will be described in detail.

Although FIG. 10 shows that the relative path loss gains for each CC is calculated and the subject of selecting the PHR enable CCs is the mobile station, the base station may directly calculate the relative path loss gains for each CC and may select the PHR enable CCs.

When the mobile station selects the PHR enable CCs, the path loss gain may be accurately measured.

When the base station selects the PHR enable CC, the base station previously knows which CC is the PHR enable CCs, such that the mobile station does not have to separately signal which CC is the PHR enable signal to the base station. When the base station selects the PHR enable CCs, the base station may inform the mobile station of which CC is the PHR enable CC through a group indicator to be described below.

Since the value measured by the mobile station is approximately similar to the is value measured by the base station, the base station may measure the relative path loss gain to select the PHR enable group in consideration of the convenience of scheduling and the burden of signaling.

The mobile station or the base station may compare the relative path loss gains for each CC with the given predetermined conditions, that is, a metric reference to divide all the configured CCs into a plurality of groups. The mobile station or the base station selects at least one of the plurality of groups obtained according to the grouping as the PHR enable group and selects the rest groups as the PHR disable group.

For example, if it is assumed that CCs are divided into two groups, that is, group A and group B based on the relative path loss gain, group A may be selected as the PHR enable group and group B may be selected as the PHR disable group. The PHR enable group is not fixed at all times. Therefore, the PHR enable group may be group A or group B according to the scheduling conditions.

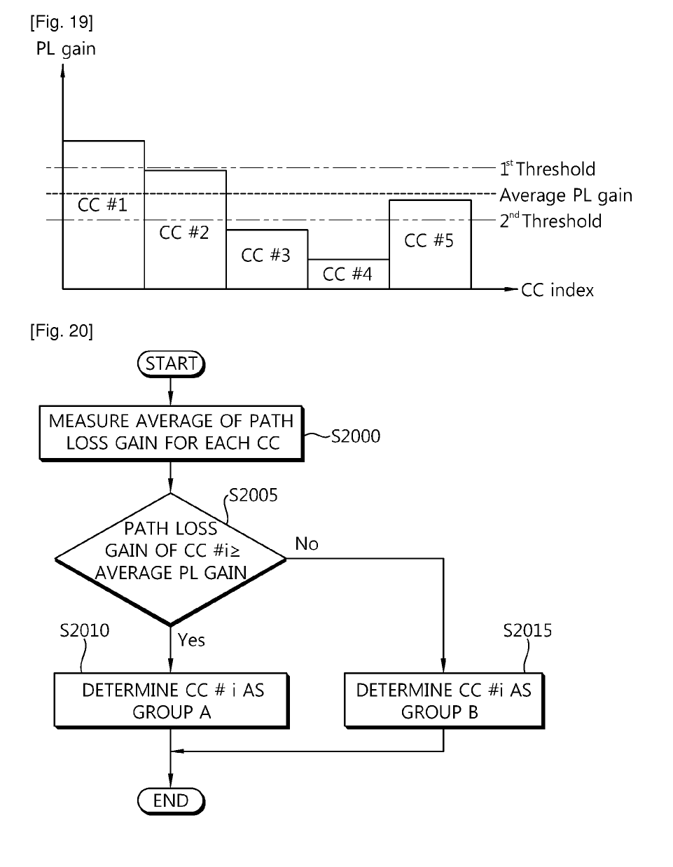

FIG. 19 is an explanation diagram for explaining a grouping method according to the exemplary embodiment of the present invention.

In an example of FIG. 19, the mobile station or the base station compares the relative path loss gains with the given threshold to set CCs whose the relative path loss gains are equal to or higher than the threshold to be group A and CCs whose the relative path loss gains are lower than the threshold to be group B. That is, CCs having the relatively higher path loss gains belong to group A and CCs having the relatively lower path loss gains belong to group B. The grouping may be performed by the calculation of metric.

In this case, the threshold may be information previously informed by the base station and the mobile station may be a value obtained through calculation by itself.

As an example of the threshold, the threshold may be an average PL gain of the relative path loss gains for all CCs. Table 6 shows an example in which the threshold of the grouping is the average PL gain of the relative path loss gains for all CCs.

TABLE 6

| Parameter | CC#1 | CC#2 | CC#3 | CC#4 | CC#5 |
|---|---|---|---|---|---|
| Path Loss Gain (dB) | 30 | 25 | 10 | 5 | 17 |
| Average PL Value | (30 + 25_10_5_17)/5 = 17.4 | | | | |
| CC Grouping | A | A | B | B | B |

Table 6 shows an example in which a total of five CCs are configured in the mobile station. The indexes of each CC are CC#1, CC#2, CC#3, CC#4, and CC#5 and the path loss gains for each CC are 30 dB, 25 dB, 10 dB, 5 dB, and 17 dB. The average of the path loss gains for each CC is (30+25+10+5+17)/5=17.4 dB. Therefore, when CCs having the path loss gain higher than the threshold are sorted as belonging to group A by setting the average PL gain of the path loss gains to be the threshold and CCs having the path loss gain lower than the threshold are sorted as belonging to group B, the path loss gains for CC#1 and CC#2 are higher than the average PL gain, such that CC#1 and CC#2 belong to group A and the path loss gains for the rest CCs are lower than the average PL gain, such that the rest CCs belong to group B.

When the grouping completes, the base station or the mobile station selects any one of group A and group B as the PHR enable group. In this case, the group that is not selected is automatically determined as the PHR disable group. Describing the case of Table 6 as an example, when group A is selected as the PHR enable group, the mobile station performs the power headroom report for CC#1 and CC#2. To the contrary, when group B is selected as the PHR enable group, the mobile station performs the power headroom report for CC#3, CC#4, and CC#5.

As another example of the threshold, the threshold may be present in plural. For example, a first threshold and a second threshold may be used as a reference of the grouping. In this case, it is assumed that the 1st threshold > the second threshold. In this case, three groups may be formed. That is, CCs having the relative path loss gains equal to or higher than the first threshold may be set to be group A, CCs having the relative path loss gains lower than the first threshold and equal to or higher than the second threshold are set to be group B, and CCs having the relative path loss gains lower than the second threshold may be set to be group C.

Even when CCs are sorted into three groups (group A, B, and C), the base station or the mobile station may select any one of the groups A, B, and C as the PHR enable group and the rest groups may be selected as the PHR disable group. Describing the path loss gains for each CC shown in Table 6 as an example, it is assumed that the first threshold is set to be 26 dB and the second threshold is set to be 12 dB. Since the path loss gain for CC#1 is higher than the first threshold, CC#1 belongs to group A. Since the path loss gains for CC#2 and CC#5 are lower than the first threshold and higher than the second threshold, CC#2 and CC#5 belong to group B. Finally, since the path loss gains for CC#3 and CC#4 are lower than the second threshold, CC#3 and CC#4 belong to group C. That is, results as shown in the following Table 7 may be obtained.

TABLE 7

| Parameter | CC#1 | CC#2 | CC#3 | CC#4 | CC#5 |
|---|---|---|---|---|---|
| Path Loss Gain (dB) | 30 | 25 | 10 | 5 | 17 |
| Threshold | First Threshold = 26 dB, Second Threshold = 12 dB | | | | |
| CC Grouping | A | A | C | C | B |

The base station or the mobile station may determine which group belongs to the PHR enable group after CCs are grouped.

For example, the base station may require CC having the specific conditions according to the conditions for appropriate scheduling. When the base station needs to know how many CCs having the path loss gain of the specific conditions are present, group Corresponding to the specific conditions in question may be selected as the PHR enable group. In the case of the above Table 6, when the base station wishes to know CCs that can perform the relatively higher amount of resource allocation, group A is selected as the PHR enable group and to the contrary, when the base station wished to know CCs that can perform the relatively lower amount of resource allocation, group B may be selected as the PHR enable group.

That is, according to the exemplary embodiment of the present invention, the base station can perform, for example, only the power headroom report for CCs required for the scheduling by grouping CCs having similar patterns, thereby reducing the resources consumed to report the power headroom.

FIG. 20 is a flow chart for explaining the grouping method of FIG. 19. In FIG. 20, the subject of the grouping may be the mobile station and the base station, as described above. In FIG. 20, for convenience of explanation, the case in which the average PL gain of the path loss is to used as the threshold for grouping is described as an example.

Referring to FIG. 20, the mobile station or the base station measures the average PL gain of the path loss gains for each CC (S2000). Since the average PL gain is a relative value, the value obtained by dividing the sum of each path loss gain by the number of all the configured CCs becomes the average PL gain.

The mobile station or the base station compares the path loss gain for CC #i with the average PL gain (S2005).

If the path loss gain of CC #i is equal to or higher than the average PL gain, the mobile station or the base station determines the CC #i as group A (S2010). In this case, group A is a set of CCs having the path loss gain higher than the average of the path loss gain of CCs configured in the mobile station.

To the contrary, if the path loss gain of CC #i is lower than the average PL gain, the mobile station or the base station determines the CC #i as group B (S2015). In this case, group B is a set of CCs having the path loss gain lower than the average of the path loss gain of CCs configured in the mobile station. The grouping may be performed by the calculation of the metric.

As described above, in FIGS. 19 and 20, the case in which the average PL gain of the path loss is used as the threshold for grouping CCs is described, but the exemplary embodiment of the present invention is not limited thereto.

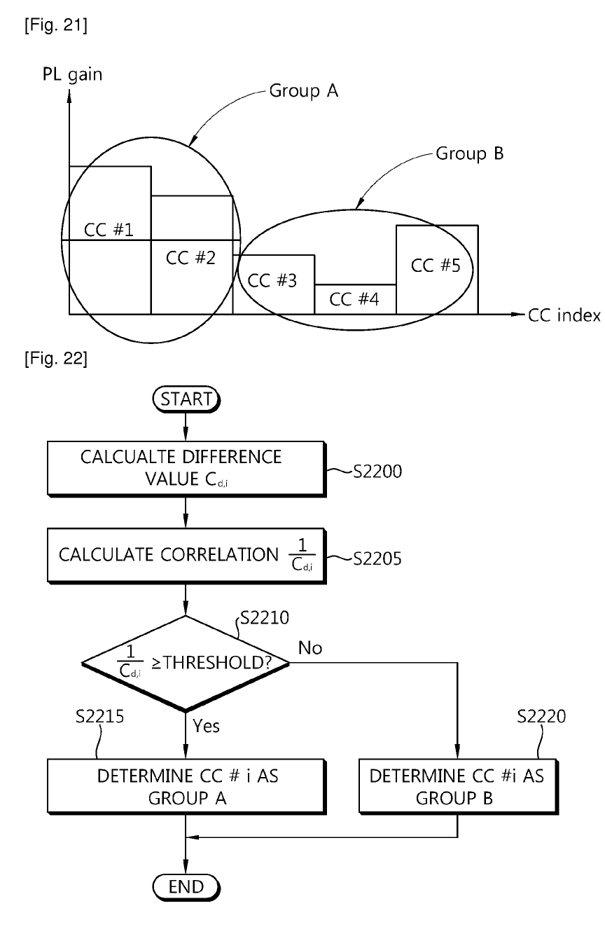

FIG. 21 is an explanation diagram for explaining a grouping method according to another exemplary embodiment of the exemplary embodiment of the present invention. In FIG. 21, an example in which the correlation value between the path loss gains for each CC is considered as the threshold for grouping CCs is described.

In detail, as an example shown in FIG. 21, the mobile station or the base station compares the correlation between CC having a maximum value among the relative path loss gains for each CC and the other CCs to set CC having the correlation equal to or higher than the threshold to be group A and CC having the correlation lower than the threshold to be group B.

A process of comparing the correlation is performed by the following method. The mobile station or the base station first obtains a difference value C_{d, i} between PLₘₐₓ that is a maximum value among the path loss gains for each CC and the path loss gains for other CCs. The correlation between CCs having the maximum path loss gains and the corresponding CC is 1/C_{d, i} that is a reciprocal number of the difference value between the maximum path loss gain and the path loss gain of the corresponding CC.

The mobile station or the base station determines CC #i to be group A by considering the correlation to be high when the correlation is equal to or higher than the threshold. To the contrary, the mobile station or the base station determines CC #i as group B by considering the correlation to be low when the correlation is lower than the threshold. In this case, the threshold may be information previously informed by the base station and the mobile station may be a value obtained through calculation by itself.

As an example of the threshold, the threshold may be the average PL gain of the correlation of all the CCs other than the maximum value.

Table 8 shows the case in which the threshold is the average PL gain of the correlation of all the CCs other than the maximum value.

TABLE 8

| Parameter | CC#1 | CC#2 | CC#3 | CC#4 | CC#5 |
|---|---|---|---|---|---|
| Path Loss Gain (dB) | 30 | 25 | 10 | 5 | 17 |
| C_{d, i}(dB) | — | 5 | 20 | 25 | 13 |
| Correlation (1/Cd, i) | — | 0.2 | 0.05 | 0.04 | 0.07 |
| Average PL Gain | (0.2 + 0.05 + 0.04 + 0.07)/4 = 0.09 | | | | |
| Correlation | — | High | Low | Low | Low |
| Comparison | | | | | |
| CC Grouping | A | A | B | B | B |

The above Table 8 shows an example of the case in which five CCs are configured in the mobile station. The indexes of each CC are CC#1, CC#2, CC#3, CC#4, and CC#5. In the case of Table 8, it is assumed that the path loss gains for each CC are 30 dB, 25 dB, 10 dB, 5 dB, and 17 dB.

Referring to FIG. 8, the maximum PLₘₐₓ is 30 dB that is the path loss gain for CC#1. Therefore, the difference value C_{d, 2} of the path loss gains for PLₘₐₓ and CC#2 is 5 dB, the is difference value C_{d, 3} of the path loss gains for PLₘₐₓ and CC#3 is 20 dB, the difference value C_{d, 4} of the path loss gain for PLₘₐₓ and CC#4 is 25 dB, and the difference value C_{d, 5} of the path loss gain for PLₘₐₓ and CC#5 is 13 dB.

Since CC having the maximum path loss gain is CC#1, when the correlation between the CC#1 and the rest CCs is obtained, the correlation between CC#1 and CC#2 is 1/C_{d, 2}=0.2, the correlation between CC#1 and CC#3 is 1/C_{d, 3}=0.05, the correlation between CC#1 and CC#4 is 1/C_{d, 3}=0.04, and the correlation between CC#1 and CC#5 is 1/C_{d, 4}=0.07. Since the average PL gain of these correlation is the threshold, the threshold is (0.2+0.05+0.04+0.07)/4=0.09. The correlation between CC#1 and CC#2 is 0.2, which is higher than the threshold 0.09, such that the correlation between CC#2 and CC#1 is high. Therefore, CC#2 is determined as group A having the higher correlation with CC#1. That is, group A is configured of CC#1 and CC#2. The rest CCs has low correlation since the correlation thereof is lower than the threshold. Therefore, CC#3, CC#4, and CC#5 are determined as group B.

When the grouping completes, the mobile station or the base station selects any one of group A and group B as the PHR enable group. In this case, the group that is not selected is automatically determined as the PHR disable group. When group A is determined as the PHR enable group, the mobile station performs the power headroom report for CC#1 and CC#2. To the contrary, when the group B is determined as the PHR enable group, the mobile station performs the power headroom report for CC#3, CC#4, and CC#5.

In the above-mentioned example, the average PL gain of the correlation is used as the threshold determining the group but as another example of the threshold, the predetermined value set by the base station may be used as the threshold according to the tolerance of the correlation. The threshold may be one and two or more.

FIG. 22 is a flow chart for explaining the grouping method of FIG. 21. Similar to the case of FIG. 20, even in the case of FIG. 22, the subject of performing the grouping may be the mobile station and the base station.

Referring to FIG. 22, the mobile station or the base station calculates the difference value C_{d, i} between of PL max that is the maximum value among the path loss gains for each CC and the path loss gain of CC #i (S2200).

The mobile station or the base station calculates the correlation that is a reciprocal number of the difference value (S2205). The mobile station or the base station compares the correlation of CC #i with the threshold (S2210).

When the correlation of CC #i is equal to or larger than the threshold, the mobile station or the base station determines the CC #i as group A (S2215). In this case, group A is a set of CCs having the higher correlation with CC having the maximum path loss gain.

When the correlation of CC #i is lower than the threshold, the mobile station or the base station determines the CC #i as group B (S2220). In this case, group B is a set of CCs having the lower correlation with CC having the maximum path loss gain.

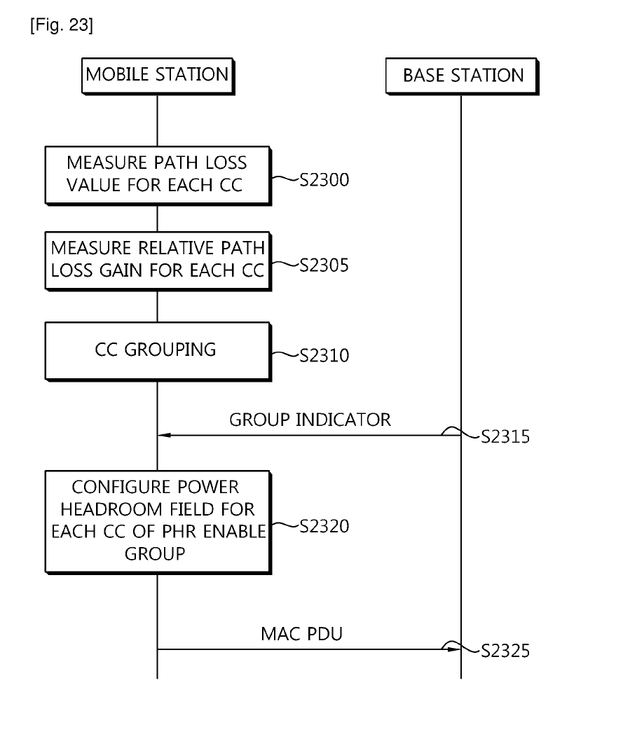

FIG. 23 is a flow chart for explaining a method for reporting power headroom by the mobile station in the multiple component carrier system according to the exemplary embodiment of the present invention. In FIG. 23, the case in which the mobile station grouping is performed and receives the group indicator from the base station to select the PHR enable group is described as the exemplary embodiment of the present invention.

Referring to FIG. 23, the mobile station measures the path loss values for each CC (S2300). This is the same as step S1800 of FIG. 18.

The mobile station measures the relative path loss gains for each CC (S2305). This is the same as step S1805 of FIG. 18. The mobile station compares the relative path loss gains for each CC with the predetermined conditions to group each CC (S2310). For example, as described above, the path loss gains for each CC compares with the predetermined threshold to group CCs and calculate the correlation with CC having the maximum path loss gain to perform the grouping as the reference. The detailed grouping method is as described above.

The mobile station receives the group indicator from the base station (S2315). The group indicator indicates the PHR enable group. The mobile station may use the group indicator to know which group the base station selects as the PHR enable group. The group indicator may be the RRC message or the MAC message. The group indicator may indicate the PHR enable group as 1-bit information. For example, when the group indicator is 1, the group indicator may indicate that group A is designated as the PHR enable group and when the group indicator is 0, the group indicator may indicate that group B is designated as the PHR enable group. Meanwhile, ones indicated by the group indicator may be contrary thereto.

The exemplary embodiment of the present invention shows the case in which the group indicator is transmitted after the CC grouping but is only an example. The group indicator is may be transmitted at any timing before step S2320. In addition, the group indicator may be information that enables CC belonging to the corresponding group in connection with the PHR transmission. In this case, the information that enables CC may be configured for the corresponding group and may be configured corresponding to each CC.

As an example, when the mobile station measures the path loss values for M CCs and then, N groups are configured in consideration of the power headroom values for each CC, the number of bits of the group indicator for the N groups may be [log 2N]. In this case, allowing the mobile station to configure the N groups for M CCs may be controlled by the base station and the grouping may be performed by using the information stored in the internal memory of the mobile station. When configuring the N groups is controlled by the base station, the grouping control information may be transmitted through the MAC or RRC message from the base station before step S2310 is performed.

In this case, the grouping control information is information associated with references (ex. Path loss value, modulation and coding scheme (MCS)), or the like, that are required at the time of performing the grouping procedure at the mobile station and the mobile station configures the group by using the grouping control information.

The mobile station configures the power headroom fields for CCs of the PHR enable group indicated by the group indicator (S2320). The power headroom field may be to configured for each of the PHR enable CCs and may be calculated by any one of the above Equations 1 to 3. In addition, the range of the value of the power headroom field may be determined by the power headroom field table of Table 1.

The mobile station transmits the MAC PDU including the power headroom field to the base station (S2325).

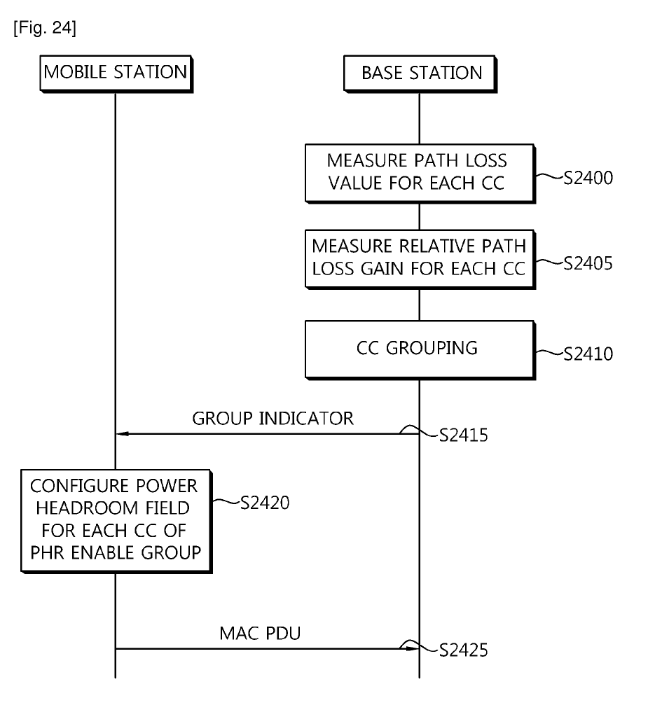

FIG. 24 is a flow chart for explaining a method for reporting power headroom by the mobile station in the multiple component carrier system according to another exemplary embodiment of the present invention. Similar to FIG. 23, even in FIG. 24, the base station performs the grouping and the base station transmits the group indicator to the mobile station.

Referring to FIG. 24, the base station measures the path loss values for each CC (S2400). This is the same as step S1800 of FIG. 18. The base station measures the relative path loss gains for each CC (S2405). This is the same as step S1805 of FIG. 18. The base station compares the relative path loss gains for each CC with the predetermined conditions to group each CC (S2410). For example, as described above, the path loss gains for each CC may compare with the predetermined threshold to group CCs and calculate the correlation with CC having the maximum path loss gain to perform the grouping as the reference. The detailed grouping method is as described above.

The base station transmits the group indicator to the mobile station (S2415). The group indicator indicates the PHR enable CCs. Since the subject of the grouping is the base station, the mobile station cannot know how the group is divided and what CC belonging to the PHR enable group is.

Therefore, the base station informs the mobile station of which CC is the PHR enable CC. To this end, the base station transmits the group indicator indicating the PHR enable CCs to the mobile station. The group indicator may indicate the PHR enable CCs as a bitmap format. Each bit corresponds to the single CC. For example, the group indicator of the bitmap type may indicate that CC corresponding to 1 is the PHR enable CC and CC corresponding to 0 is the PHR disable CC.

In more detail, it is assumed that CC#1, CC#2, CC#3, CC#4, and CC#5 that are a is total of five CCs are configured in the mobile station. When the group indicator of the bitmap type transmitted from the base station is 01001, since the bits corresponding to CC#2 and CC#5 are set to be 1 and the bits corresponding to the rest CCs are set to be 0, the PHR enable CCs are CC#2 and CC#5 and the rest CCs are the PHR disable CCs.

The group indicator may be the RRC message or the MAC message.

In this case, the exemplary embodiment of the present invention shows the case in which the group indicator is transmitted after the CC grouping but is only an example. The group indicator may be transmitted at any timing before step S2020.

The mobile station configures the power headroom fields for the PHR enable CCs indicated by the group indicator (S2420). The power headroom field may be configured for each of the PHR enable CCs and may be calculated by any one of the above Equations 1 to 3. In addition, the range of the value of the power headroom field may be determined by the power headroom field table of Table 1.

The mobile station transmits the MAC PDU including the power headroom field to the base station (S2425).

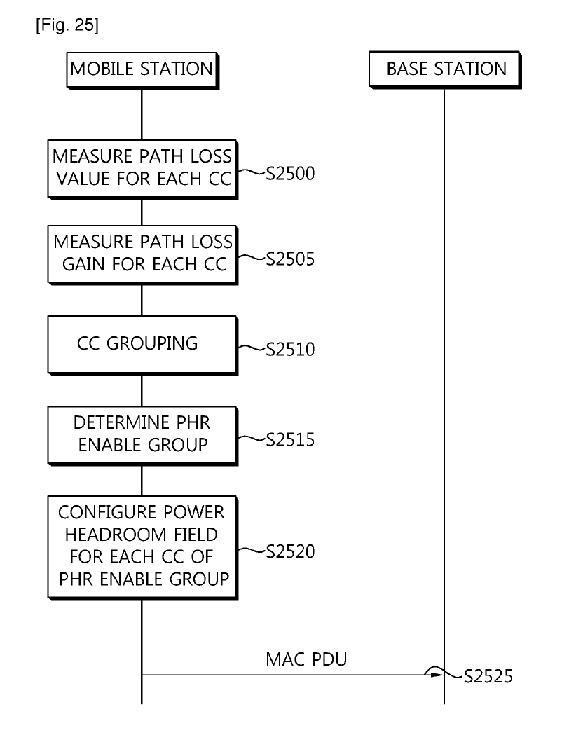

FIG. 25 is a flow chart for explaining a method for reporting power headroom by the mobile station in the multiple component carrier system according to another exemplary embodiment of the present invention. The exemplary embodiment shown in FIG. 25 describes the case in which the mobile station performs the grouping and selects the PHR enable group by itself without receiving the group indicator from the base station.

Referring to FIG. 25, the mobile station measures the path loss values for each CC (S2500). This is the same as step S1800 of FIG. 18. The mobile station measures the relative path loss gains for each CC (S2505). This is the same as step S1805 of FIG. 18. The mobile is station compares the relative path loss gains for each CC with the predetermined conditions to group each CC (S2510). For example, as described above, the path loss gains for each CC may compare with the predetermined threshold to group CCs and calculate the correlation with CC having the maximum path loss gain to perform the grouping as the reference. The detailed grouping method is as described above.

The mobile station selects the PHR enable group (S2515). As described above, unlike FIG. 23 or 24, FIG. 25 shows the case in which the mobile station selects the PHR enable group. The mobile station may select at least one of the plurality of groups as the PHR enable group since there is no group indicator transmitted from the base station.

The mobile station configures the power headroom fields for CCs of the selected PHR enable group (S2520). The power headroom field may be configured for each of the PHR enable CCs and may be calculated by any one of the above Equations 1 to 3. In addition, the range of the value of the power headroom field may be determined by the power headroom field table of Table 1.

The mobile station transmits the MAC PDU including the power headroom field to the base station (S2525).

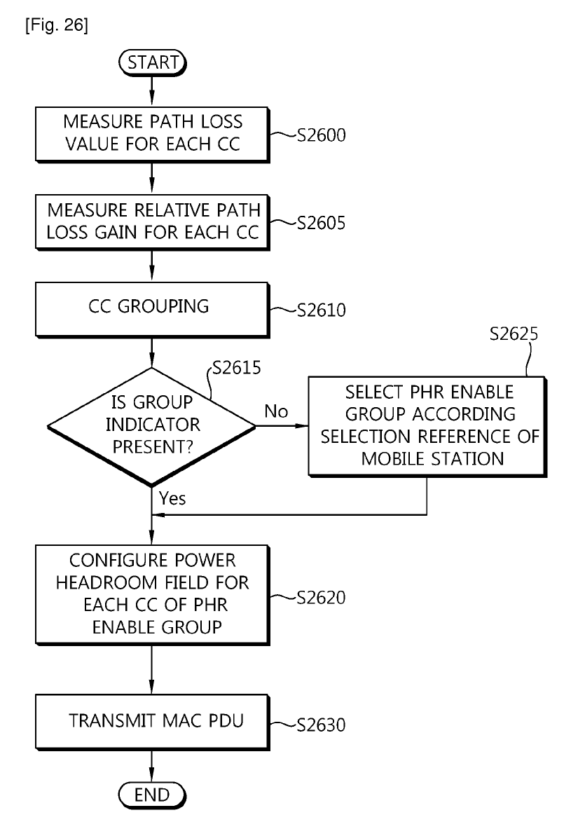

FIG. 26 is a flow chart for explaining a method for transmitting power headroom by the mobile station in the multiple component carrier system according to another exemplary embodiment of the present invention.

Referring to FIG. 26, the mobile station measures the path loss values for each CC (S2600). This is the same as step S1800 of FIG. 18. The mobile station measures the relative path loss gains for each CC (S2605). This is the same as step S1805 of FIG. 18. The mobile station compares the relative path loss gains for each CC with the predetermined conditions to is group each CC (S2610). For example, as described above, the path loss gains for each CC may compare with the predetermined threshold to group CCs and calculate the correlation with CC having the maximum path loss gain to perform the grouping as the reference. The detailed group method is as described above.

The mobile station determines whether the group indicator is present (S2615). If the group indicator is present, the mobile station configures the power headroom fields for each CC of the PHR enable group indicated by the group indicator (S2620). If the group indicator is not present, the mobile station selects the PHR enable group according to its own selection reference (S2625) and configures the power headroom fields for each CC of the selected PHR enable group (S2620). The mobile station transmits the MAC PDU including the configured power headroom field to the base station (S2630).

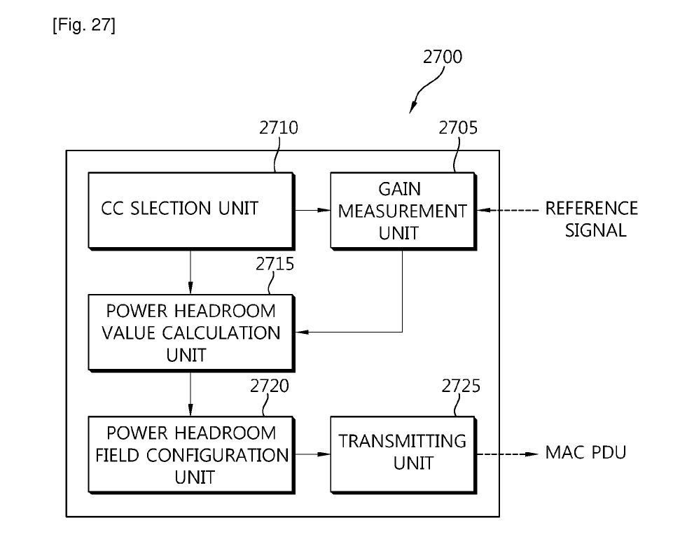

FIG. 27 is a block diagram showing an apparatus for reporting power headroom in the multiple component carrier system according to the exemplary embodiment of the present invention.

Referring to FIG. 27, an apparatus 2700 for reporting power headroom includes a gain measurement unit 2705 that measures the path loss value and the relative path loss gain, a CC selection unit 2710 that selects the PHR enable CCs, a power headroom value calculation unit 2715 that obtains the power headroom value for the PHR enable CC, a power headroom field configuration unit 2720 that configures a power headroom field (PH field) including the power headroom value, and a transmit unit 2725 that configures and transmits the MAC PDU including the power headroom field.

The gain measurement unit 2705 may measure the path loss value based on the RSRP as shown in the above Equation 5.

In addition, the gain measurement unit 2705 may measure the relative path loss gains for each CC depending on the above Equation 6.

The channel gain reflects the path loss gain and thus, shows the channel conditions. That is, when the channel gain is represented by a sum of a large-scale fading gain and a small-scale fading gain, the path loss gain corresponds an element of the large-scale fading gain. Meanwhile, the relative path loss gain indicates a normalized path loss gain.

The CC selection unit 2710 selects at least one of the plurality of configured CCs according to the predetermined conditions. In this case, at least CC selected is the PHR enable CC and the method for selecting the PHR enable CCs may be performed by the grouping and the selection of the PHR enable group. As the grouping method, the method described by FIGS. 19 and 21 may be used. The selection of the PHR enable group is performed by allowing the CC selection unit 2710 to receive the group indicator from the base station and select the group indicated by the group indicator. Alternatively, the CC selection unit 2710 directly selects the PHR enable groups by the predetermined selection reference.

The power headroom value calculation unit 2715 calculates the power headroom values for the PHR enable CCs by any one of the above Equations 1 to 3.

The power headroom field configuration unit 2720 configures the power headroom fields corresponding to each power headroom value as shown in the above Table 1.

A CC may be defined as a concept, including a DL CC or both a DL CC and a UL CC and may also be defined as a cell. In other words, a cell may be defined as only DL frequency resources (e.g., component carriers) to which a radio signal recognizable by an MS in a certain area can arrive. Alternatively, the cell may be defined as a pair of UL frequency resources that an MS, capable of receiving a signal from a BS, can transmit the UL frequency is resources to the BS through DL frequency resources and a DL frequency.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1. A method for transmitting power information, the method comprising:
determining whether any one of a case in which path loss variations is higher than a specific threshold and a prohibit power headroom report timer expires, a case in which a periodic power headroom report timer expires, and a case in which the power headroom report is configured or re-configured by an upper layer is occurred in a case in which a mobile station has uplink resources for new transmit; and
triggering the power headroom report when any one of the cases is occurred,
wherein the power headroom is a difference value between maximum transmit power configured in the mobile station for each component carrier and transmit power estimated for actual uplink transmission, and
the power headroom report includes a power headroom identification field that identifies a component carrier that the reported power headroom is for and power headroom fields that indicate a level of the reported power headroom, and the power headroom report is transmitted to a base station through a medium access control protocol data unit (MAC PDU).

2. The method of claim 1, wherein the MAC PDU includes a medium access control (MAC) subheader, an MAC control element, and an MAC service data unit (SDU), wherein the MAC subheader including the power headroom identification field and the MAC control element or the MAC SDU including the power headroom fields.

3. The method of claim 2, wherein the MAC control element further includes a mode field that identifies whether the MAC PDU includes the power headroom fields for all the component carriers configured in the mobile station or includes the power headroom fields for some component carriers.

4. The method of claim 1, wherein the MAC PDU includes a plurality of power headroom identification fields and a plurality of power headroom fields.

5. The method of claim 1, wherein the transmit power estimated for the actual uplink transmission is transmit power of a physical uplink shared channel (PUSCH) or a sum of the transmit power of the PUSCH and transmit power of a physical uplink control channel (PUCCH).

6. The method of claim 1, wherein the transmit power estimated for the actual uplink transmission is a sum of transmit power of the physical uplink shared channel (PUSCH) and transmit power of the physical uplink control channel (PUCCH).

7. The method of claim 1, further comprising: prior to transmitting the MAC PDU to the base station,
requesting uplink scheduling for transmitting the MAC PDU to the base station; and
receiving uplink scheduling information from the base station,
wherein the MAC PDU is transmitted using uplink resources according to the uplink scheduling information.

8. The method of claim 1, further comprising selecting at least one component carrier, which is a target of the power headroom report, among the plurality of component carriers configured in the mobile station based on a metric using path loss gains of each component carrier as a parameter,
wherein the path loss gain is a relative value determined by a difference between theoretical reference signal power of the component carrier and reference signal power actually received by the mobile station.

9. The method of claim 8, wherein the metric performs calculation that compares an amount of the path loss gain with a threshold.

10. The method of claim 9, wherein the threshold is an average of the path loss gain for the plurality of component carriers.

11. The method of claim 9, wherein the path loss gain for at least one selected component carrier is equal to or higher than the threshold.

12. The method of claim 8, wherein the metric performs calculation that compares an amount of a correlation with the threshold,
the correlation is obtained based on a difference between the path loss gain and a maximum path loss gain, and
the maximum path loss gain is a maximum value among the path loss gains for each of the plurality of component carriers.

13. The method of claim 12, wherein the correlation is a reciprocal number of the difference between the path loss gain and the maximum path loss gain.

14. The method of claim 12, wherein the threshold is an average of the correlation for the rest carriers other than the component carriers having the maximum path loss gain among the plurality of component carriers.

15. A method for reporting power headroom in a radio communication system supporting a plurality of component carriers, the method comprising:
mapping power headroom values subtracting a sum of transmit power used in each component carrier from maximum transmit power of a mobile station to indexes divided by 6 bits configured in consideration of relative parameters of each component carrier;
configuring a medium control access (MAC) protocol data unit (PDU) including a header that includes a logical channel ID (LCID) indicating a power headroom report, information that indicates component carriers in which the power headroom report is triggered among the plurality of component carriers, and indexes to which the power headroom values of the component carriers for which the power headroom report triggered are mapped; and
transmitting the configured MAC PDU through an uplink.

16. The method of claim 15, wherein the information that indicates component carriers in which the power headroom report is triggered among the plurality of component carriers, and the indexes to which the power headroom values of the component carriers for which the power headroom report triggered are mapped are included in a medium control access (MAC) control element of the MAC PDU.

17. A method for reporting power headroom in a radio communication system supporting a plurality of component carriers, the method comprising:
mapping power headroom values subtracting a sum of transmit power used in each component carrier from maximum transmit power of a mobile station to indexes divided by 6 bits configured in consideration of relative parameters of each component carrier;
configuring a medium control access (MAC) protocol data unit (PDU) including a header that includes a logical channel ID (LCID) configured corresponding to component carriers in which a power headroom report is triggered among the plurality of component carriers and indexes to which the power headroom values of the triggered component carriers are mapped; and
transmitting the configured MAC PDU through an uplink.

18. A method for reporting power headroom, the method comprising:
measuring path loss gains for each of the plurality of component carriers configured in a mobile station;
categorizing the plurality of component carriers into a plurality of groups by comparing the path loss gains with predetermined conditions;
selecting at least one group of the plurality of groups;
configuring power headroom fields (PH field) that indicate the power headroom values for each of all the component carriers belonging to the at least one selected group; and
transmitting the medium control access (MAC) protocol data unit (PDU) including the configured power headroom fields to a base station.

19. The method of claim 18, wherein the at least one selected group is configured of the component carriers indicated by an indicator in a bitmap type received from the base station among the plurality of component carriers.

20. The method of claim 18, wherein the at least one selected group is selected by the mobile station through comparing values for the path loss gains with a predetermined threshold, in the plurality of component carriers.
